(19) United States
(12) Patent Application Publication
(10) Pub. No.: US 2022/0075101 A1
(43) Pub. Date: Mar. 10, 2022

(54) LENS COMPRISING AN ADJUSTABLE OPTICAL POWER

(71) Applicant: OPTOTUNE CONSUMER AG, Dietikon (CH)

(72) Inventors: Stephen SMOLKA, Zürich (CH); Manuel ASCHWANDEN, Allenwinden (CH); Johannes HAASE, Dietikon (CH); Sanggyu BIERN, Zürich (CH); Roman PATSCHEIDER, Winterthur (CH)

(73) Assignee: OPTOTUNE CONSUMER AG, Dietikon (CH)

(21) Appl. No.: 17/418,820

(22) PCT Filed: Dec. 20, 2019
(86) PCT No.: PCT/EP2019/086837

§ 371 Date: Jun. 27, 2021

(30) Foreign Application Priority Data
Dec. 28, 2018 (EP) 18248279.4

(51) Int. Cl. G02B 3/14; G02B 7/02; G02B 26/00; G03B 17/12

(52) U.S. Cl. CPC G02B 3/14; G03B 17/12; G02B 26/004; G02B 7/028

(57) ABSTRACT

The present invention relates to a lens (1) having an adjustable optical power, wherein the lens (1) comprises a container (2), wherein the container (2) comprises: a lens volume (V) filled with a transparent fluid (F1), a reservoir volume (R1) filled with the transparent fluid (F1) and connected to the lens volume (V), a frame structure (3) forming a lateral wall of the container (2), wherein the frame structure comprises a first recess (30) for accommodating at least a portion of the lens volume (V), and wherein the frame structure (3) comprises a second recess (31) for accommodating at least a portion of the reservoir volume (R1), an elastically deformable and transparent membrane (4) connected to the frame structure, a lens shaping element (5) connected to the membrane, wherein the lens shaping element (5) comprises a circumferential edge (50a) defining an area (4a) of the membrane (4) having an adjustable curvature, a transparent bottom wall (6) connected to the frame structure (3) so that the lens volume (V) is arranged between said area (4a) of the membrane (4) and said bottom wall, and an elastically deformable wall member (4b) adjacent the reservoir volume (R1).

The present invention relates to a lens having an adjustable optical power (or focal length). Particularly, the lens is suitable for use in an optical device such as a tele objective, wide angle objective, macro objective or zoom objective.

Such optical zoom systems particularly comprise two basic characteristics, namely an adjustable focal length or optical power (the optical power, also denoted as focal power, is equal to the reciprocal of the focal length) as well as a fixed image plane. Conventional optical zoom systems usually comprise several lens assemblies which can be displaced with respect to one another. Here, the focal length of the optical zoom system is continuously adjusted by said displacements of lens assemblies. Particularly, the individual lens assembly has to be displaced in a pre-defined manner so that complex mechanical/motorized systems are necessary for providing proper zooming.

Based on the above, the problem to be solved by the present invention is to provide an improved lens that comprises a comparatively small installation space, allows easy installation with respect to a lens barrel of an optical zoom device as well as precise actuation for adjusting the optical power of the lens.

This problem is solved by a lens having the features of claim 1.

Preferred embodiments of the present invention are stated in the respective sub claims and are described below.

According to claim 1 a lens having an adjustable optical power is disclosed, wherein the lens comprises a container, wherein the container comprises:
a lens volume filled with a transparent fluid,
a reservoir volume filled with the transparent fluid and connected to the lens volume,
a frame structure forming a lateral wall of the container, wherein the frame structure comprises a first recess (particularly in the form of a through opening) for accommodating at least a portion of the lens volume, and wherein the frame structure comprises a second recess for accommodating at least a portion of the reservoir volume,
an elastically deformable and transparent membrane connected to the frame structure,
a lens shaping element connected to the membrane, wherein the lens shaping element comprises a circumferential (e.g. circular) edge defining an area of the membrane having an adjustable curvature,
an at least partially transparent bottom wall connected to the frame structure so that the lens volume is arranged between said area of the membrane and said wall,
an elastically deformable wall member adjacent the reservoir volume.

Particularly, in all embodiments described herein, the transparent fluid and particularly the further fluid (see below), preferably is a transparent liquid, respectively.

According to an embodiment of the present invention, the elastically deformable wall member is configured to be deformed to pump fluid from the reservoir volume into the lens volume to adjust a curvature of said area of the membrane and therewith an optical power of the lens, or wherein the wall member is configured to be deformed to pump fluid from the lens volume into the lens reservoir volume to adjust the curvature of the said area of the membrane and therewith the optical power of the lens.

Furthermore, according to an embodiment of the present invention, the elastically deformable wall member is configured to be deformed to pump fluid from the reservoir volume into the lens volume to increase a curvature of said area of the membrane and therewith an optical power of the lens, or wherein the wall member is configured to be deformed to pump fluid from the lens volume into the reservoir volume to decrease a curvature of the said area of the membrane and therewith the optical power of the lens.

Particularly, when the lens is converging (e.g. said area of the lens is convex) the optical power is positive, whereas the optical power is negative in case the lens is diverging (e.g. said area of the lens is concave). Particularly, increasing the curvature of said area of the membrane can e.g. mean that said area of the membrane changes from a flat state to a convex state; or from a convex state to a more pronounced convex state; or from a concave state to a less pronounced concave state, to a flat state or a to convex state. Furthermore, decreasing the curvature of said area of the lens can mean that said area changes from a flat state to a concave state; or from a concave state to a more pronounced concave state; or from a convex state to a less pronounced convex state, to a flat state or to a concave state.

Furthermore, according to an embodiment of the present invention, the lens comprises a piston structure connected (particularly glued) to said deformable wall member for deforming the wall member by pushing against the wall member or pulling on the wall member.

Furthermore, according to an embodiment of the present invention, the piston structure is configured to be connected to an actuator for moving the piston structure.

Particularly, in an embodiment, the piston structure comprises an octagonal bottom surface connected to the elastically deformable wall member. The bottom surface may also have a different shape. Preferably, the bottom surface comprises a shape that corresponds to a shape of a cross-section of the reservoir volume parallel to the bottom surface and/or of the elastically deformable wall member parallel to the bottom surface.

Furthermore, according to an embodiment of the present invention, the piston structure is formed by a plate comprising said bottom surface as well as an opposing octagonal top surface, wherein the top surface comprises a hole (e.g. a blind hole or a through hole) configured to receive a portion of an actuator (e.g. for positioning and/or connecting the actuator with respect to the piston structure). In case of a through hole, the hole extends from the top surface to the bottom surface of the piston structure.

Furthermore, according to an embodiment, the reservoir volume comprises an octagonal cross-sectional area (e.g. parallel to said surfaces of the plate/piston structure). The reservoir volume can also have other cross-section shapes (see above).

Furthermore, according to an embodiment of the present invention, the reservoir volume of the container is arranged laterally next to the lens volume of the container in a direction perpendicular to the optical axis of the lens, wherein particularly the container comprises an elongated shape in said direction.

Furthermore, according to an embodiment of the present invention, the frame structure is formed by at least one monolithic plate member, particularly in form of an injection molded part. According to an alternative embodiment, the frame structure is comprised of sheets (particularly metal sheets) stacked on top of one another.

Particularly, according to an embodiment, the frame structure comprises a top sheet connected to the membrane and at least one further sheet connected to the top sheet. In an embodiment, the at least one further sheet can comprise a smaller inner diameter in the region of the reservoir volume and/or in the region of the lens volume compared to the top sheet, so that an internal side of the frame structure of the container forms a step.

Furthermore, according to an embodiment of the present invention, the bottom wall is formed by a flat transparent rigid plate. Particularly, this plate can be formed out of a glass or a polymer. Alternatively, the bottom wall can be formed by or can comprise a rigid lens that can be formed out of a glass or a polymer.

Furthermore, alternatively, the bottom wall of the container can comprise a further transparent and elastically deformable membrane connected to the frame structure.

In addition, according to an embodiment, the transparent wall comprises a transparent rigid plate (or a rigid lens) arranged on the further membrane, so that the further membrane is arranged between the frame structure and the transparent plate (or rigid lens) of the bottom wall. Particularly, the transparent plate of the bottom wall can be a circular plate. Particularly, the fact that the transparent plate or rigid lens (bottom wall of the container) can be rigid means that it is more rigid than the elastically deformable membrane of the bottom wall. The rigid plate of the bottom all may also comprise other optical properties. Particularly, the rigid plate of the bottom wall can be any transparent optical element.

Further, according to an embodiment, the lens shaping element is e.g. formed as a flat plate and comprises a first through-opening forming said circumferential edge for defining said area of the membrane, wherein the first through-opening is closed by said area of the membrane.

Particularly, in an embodiment, for protecting the curvature-adjustable area of the membrane, the lens shaping element is connected to the frame structure such that the membrane is arranged between the frame structure and the lens shaping element, so that particularly the lens shaping element protrudes beyond said area of the membrane along an optical axis of the lens.

Particularly, the lens shaping element protrudes such from said area of the membrane along the optical axis of the lens that the container can be inserted perpendicular to an optical axis of a lens barrel into a slot of the lens barrel in a form fitting manner such that the lens barrel cannot contact said area of the membrane upon insertion of the container into the slot of the lens barrel. Particularly, said slot can also be arranged at an end of the lens barrel adjacent to an opening of the lens barrel.

Further, according to an embodiment of the present invention, the lens shaping element is connected to the frame structure such that the lens shaping element is arranged between the frame structure and the membrane.

Further, according to an embodiment of the present invention, the first recess of the frame structure comprises an inner diameter that is larger than an inner diameter of the circumferential edge of the first through-opening of the lens shaping element. This guarantees that the membrane protrudes inwards from the circumferential edge of the lens shaping element and not from portions of the frame structure such that the circumferential edge being the last contact line defines the shape of said area of the membrane of the lens.

Furthermore, according to an embodiment, the lens shaping element is a ring member that is attached to an exterior side of the membrane that faces away from the fluid in the container or to an interior side of the membrane (which interior side particularly faces away from the exterior side) so that the lens shaping member is particularly immersed in the fluid, wherein the ring member comprises a through-opening forming said circumferential edge, wherein particularly the through-opening is closed by said area of the membrane.

Further, according to an embodiment of the present invention, the lens shaping element comprises a second through-opening, wherein the second through-opening is covered by the elastically deformable wall member (e.g. by the membrane, too).

Further, according to an embodiment of the present invention, the second through-opening of the lens shaping element comprises an octagonal shape.

Further, according to a preferred embodiment of the present invention, the elastically deformable wall member of the container is formed by the membrane, i.e., the membrane particularly extends over both recesses of the frame structure and covers the lens volume as well as the reservoir volume.

Further, according to an alternative embodiment of the present invention, the elastically deformable wall member may also be positioned on a side of the container of the lens that faces away from the side on which said area of the transparent and elastically deformable membrane is arranged and may form a portion of said bottom wall of the container, wherein particularly the elastically deformable wall member can now be formed by the further membrane that is a part of the bottom wall of the container.

Here, particularly, the frame structure can comprise a first frame element forming a portion of the lateral wall of the container, wherein the first frame element forms a portion of the first recess of the frame structure and a portion of the second recess of the frame structure, wherein these portions of said recesses are connected to provide a flow connection between the lens volume and the lateral volume of the container. Furthermore, the frame structure comprises an adjacent parallel second frame element which forms a portion of the first recess of the frame structure and a portion of the second recess of the frame structure, wherein these recess portions are separated. Particularly, the portion of the first recess of the second frame element is covered by said bottom wall of the container and the portion of the second recess of the second plate is covered by the elastically deformable member (which forms a portion of the bottom wall) to which the piston structure (see above) is connected. Particularly, the bottom wall comprises the further membrane which covers both portions of the first and the second recess of the second frame element (and forms the elastically deformable wall member of the reservoir volume), wherein the transparent rigid plate of the bottom wall covers the portion of the first recess of the second frame element, and wherein the further membrane is arranged between the transparent rigid plate of the bottom wall and the second frame element

Further, according to an embodiment of the present invention, the membrane comprises a larger thickness (or a larger stiffness due to prestraining or a different material, particularly a different polymer, of the membrane) than the further membrane to reduce a gravity-induced coma aberration of the area of the membrane.

Further, according to an embodiment of the present invention, the frame structure is configured to expand (e.g. predominantly along the optical axis of the lens) with increasing temperature to reduce a change in the optical power of the lens due to an increase of the volume of the fluid with increasing temperature and due to a decrease of the refractive index of the fluid with increasing temperature.

Further, according to an embodiment of the present invention, for balancing an increase in optical power of the lens due to an increase of the volume of the fluid with increasing temperature and a decrease of the optical power due to a decrease of the refractive index of the fluid with increasing temperature, the reservoir volume is delimited by a tilted inside of the second recess of the frame structure (or comprises a step on an inside of the frame structure) so as to reduce the reservoir volume and/or a channel providing a flow connection between the lens volume and the reservoir volume comprises a height along the optical axis of the lens, which height is smaller than a height of the lens volume and/or of the reservoir volume along the optical axis of the lens, and/or wherein said channel comprises a width perpendicular to the optical axis of the lens that is smaller than a diameter of the reservoir volume and/or than a diameter of the lens volume.

Further, according to an embodiment of the present invention, the container comprises an elastically deformable wall region adjacent the reservoir volume for compensating a thermal drift of the optical power of the lens, and wherein the lens comprises a compensation actuator configured to deform said elastically deformable wall region to counteract a thermal drift of the optical power of the lens.

Further, according to an embodiment of the present invention, the lens comprises a temperature sensor for measuring a temperature of the lens (particularly of the fluid in the reservoir and/or lens volume), wherein the lens is configured to control the compensation actuator using an output signal of the temperature sensor that is indicative of said temperature to counteract the thermal drift of the optical power of the lens. The temperature sensor can be located at the lens shaping element or frame structure, particularly in case this element or frame structure is thermally conductive (e.g. formed out of a metal).

Further, according to an embodiment of the present invention, the fluid comprises a refractive index (n_{F}) in the range from 1.2 to 1.4, and/or wherein the transparent and elastically deformable membrane (n_{membrane}) comprises a refractive index in the range from 1.3 to 1.6, and/or wherein the transparent plate (of the bottom wall) comprises a refractive index (n_{bottom}) in the range from 1.4 to 1.6.

Further, according to an embodiment of the present invention, the container encloses a further lens volume filled with a further transparent fluid, wherein the further lens volume is separated from the lens volume by a transparent and elastically deformable separating membrane, such that the further fluid is arranged between the fluid of the lens volume and the bottom wall, wherein for at least partially compensating a gravity-induced coma aberration of said area of the membrane, the further fluid comprises a density and a refractive index, wherein the density of the further fluid is smaller than a density of the fluid, and wherein the refractive index of the further fluid is larger than a refractive index of the fluid.

Here, particularly, the frame structure can comprise a first frame element forming a portion of the lateral wall of the container, wherein the first frame element forms a portion of the first recess of the frame structure and a portion of the second recess of the frame structure, wherein these portions of said recesses are connected to provide a flow connection between the lens volume and the lateral volume of the container. Furthermore, the frame structure comprises an adjacent parallel second frame element which comprises a recess accommodating the further lens volume for receiving the further fluid, wherein said separating membrane is arranged between the first frame element and the second frame element. Furthermore, particularly, the recess of the second frame element is covered by said bottom wall of the container. Thus, the second frame element forms a coma aberration correction plate.

Further, according to an embodiment of the present invention, the container of the lens comprises a further reservoir volume connected to the lens volume of the container (e.g. via a further channel), wherein the container comprises an elastically deformable further wall member adjacent the further reservoir volume of the container.

Particularly, in an embodiment, the reservoir volume and the further reservoir volume of the container face each other in a direction perpendicular to the optical axis of the lens and are arranged on opposite sides of the lens volume.

Further, according to an embodiment, the frame structure of the container of the first lens comprises a third recess for accommodating at least a portion of the further reservoir volume of the container, which third recess is covered by the further wall member of the container and particularly by the bottom wall of the container of the first lens.

Further, according to an embodiment, the lens shaping element comprises a third through-opening, wherein the third through-opening covered by the elastically deformable further wall member (e.g. by the membrane, too).

Particularly, in an embodiment, the third through-opening comprises an octagonal shape (or another shape that particularly corresponds to a shape of a cross section of the further reservoir volume).

Furthermore, according to an embodiment, the further wall member is formed by the transparent and elastically deformable membrane.

Furthermore, according to an embodiment, the lens comprises a further piston structure connected (particularly bonded or glued) to said further wall member for deforming the further wall member by pushing against the further wall member or pulling on the further wall member.

Particularly, the further piston structure is configured to be connected to a further actuator for moving the further piston structure.

Particularly, according to an embodiment, the further piston structure comprises an octagonal bottom surface connected to the elastically deformable further wall member.

Furthermore, the further piston structure is formed by a plate comprising said bottom surface as well as an opposing octagonal top surface, wherein the top surface comprises a hole (e.g. a blind hole or a through-hole) configured to receive a portion of the further actuator.

Furthermore, particularly, the further reservoir volume comprises an octagonal cross-sectional area parallel to said surface of the plate forming the further piston structure.

Furthermore, according to an embodiment of the present invention, the lens comprises a further actuator that is configured to act on the further piston structure to pump fluid from the further reservoir volume into the lens volume of the first lens or from the lens volume into the further reservoir volume so as to change the curvature of said area of the membrane and therewith the optical power of the lens.

According to an embodiment of the present invention, also the further actuator is configured to be assembled separately with respect to the container of the lens.

Particularly, the further actuator can be one of the following actuators: a voice coil or Lorentz force motor, a piezo drive, a screw drive, a thermoactive actuator, an SMA (shape memory alloy) actuator, a reluctance force actuator.

Further, according to an embodiment of the present invention, the actuator used for acting on the piston structure comprises a support structure and a mover that is connected to the piston structure and configured to be moved relative to the support structure in a first motion direction so that the piston structure is pushed by the mover against the elastically deformable wall member of the container to pump fluid from the reservoir volume into the lens volume part, and relative to the support structure in a second motion direction so that the mover pulls on the elastically deformable wall member of the container through the piston structure to pump fluid from the lens volume into the reservoir volume.

Particularly, the two motion directions point in opposite directions and are parallel to the optical axis of the lens. Particularly, the mover can be integrally connected to the piston structure or engages with the hole of the piston structure (see above).

Particularly, when the mover pushes the piston structure against the elastically deformable wall member, the latter develops a dent and thus pushes fluid out of the reservoir volume into the lens volume such that said area of the lens develops a corresponding convex shape and the optical power of the lens increases. Further, when the mover pulls on the piston structure, the latter pulls on the elastically deformable wall member which then bulges outwards and thus pumps fluid from the lens volume into the reservoir volume such that the convex curvature of the area of the lens and therewith the optical power decreases.

Particularly, according to an embodiment, the support structure is mounted to the container, particularly to the lens shaping element. Therefore, a reference point for the actuation of the piston structure is not influenced by a thermal drift (e.g. thermal expansion of the container). Thus, the actuator is thermally decoupled from the lens (e.g. heating from an electrical coil of the actuator).

Particularly, the support structure can form a housing of the actuator.

Furthermore, according to an embodiment of the present invention, the mover comprises an electrical coil, wherein the electrical coil comprises a first portion in which an electrical current generated in the coil flows in a first current direction, and wherein the electrical coil comprises a second portion in which the electrical current generated in the coil flows in a second current direction that is opposite the first current direction.

Furthermore, according to an embodiment of the present invention, a first and a second magnet structure is mounted to the support structure such that the coil is arranged between the two magnet structures, wherein each magnet structure comprises a first portion having a first magnetization and a second portion having a second magnetization that is oriented opposite to the first magnetization.

Furthermore, according to an embodiment of the present invention, the first portion of the first magnet structure faces the first portion of the second magnet structure, and wherein the first portion of the coil is arranged between the first portion of the first magnet structure and the first portion of the second magnet structure, and wherein the second portion of the first magnet structure faces the second portion of the second magnet structure, and wherein the second portion of the coil is arranged between the second portion of the first magnet structure and the second portion of the second magnet structure.

Furthermore, according to an embodiment of the present invention, the first magnetization of the first portions of the magnet structures extends perpendicular to the first current direction, and wherein the second magnetizations of the second portion of the magnet structures extend perpendicular to the second current direction such that a Lorentz force acts on each portion of the coil when an electrical current flows through the electrical coil, which Lorentz forces move the mover in the first motion direction or in the second motion direction depending on the orientation of the first and second current direction (i.e. the polarity of the electrical coil).

Furthermore, according to an embodiment of the present invention, the lens comprises a further actuator that is configured to act on the further piston structure to pump fluid from the reservoir volume into the lens volume or from the lens volume into the reservoir volume so as to change the curvature of said area of the membrane and therewith the optical power of the lens. Particularly, the further actuator can be configured as the specific actuator described above comprising said electrical coil and two magnet structures. Particularly, in an embodiment, the further actuator comprises a support structure and a mover, too, that is connected to the further piston structure and configured to be moved relative to the support structure of the further actuator in a first motion direction so that the further piston structure is pushed by the mover of the further actuator against the elastically deformable further wall member of the container of the lens to pump fluid from the further reservoir volume into the lens volume, and relative to the support structure of the further actuator in a second motion direction so that the mover of the further actuator pulls on the elastically deformable further wall member of the container of the lens through the further piston structure to pump fluid from the lens volume into the further reservoir volume.

According to yet another embodiment, the lens shaping element of the lens can also be formed by the frame structure itself which then comprises said circumferential edge, wherein here the lens comprises a protection plate member arranged on top of the membrane to protect the membrane so that the membrane is sandwiched between the frame structure and the protection plate member. Preferably, the protection plate member comprises a first through-opening aligned with the first recess associated with the lens volume and a second through-opening aligned with the second recess associated with the reservoir volume. Preferably, the membrane is glued to the frame structure, particularly to said top sheet of the frame structure. Furthermore, particularly, the lens shaping element can be formed by said top sheet of the frame structure described above which top sheet then comprises said circumferential edge. Preferably, the top sheet is formed of a material that can be formed very precisely.

Particularly, in case the lens shaping element is formed by the frame structure (for example by the top sheet) said circumferential edge of the frame structure (particularly of the top sheet) preferably comprises an inner diameter that is smaller than the inner diameter of the corresponding through-opening of the protection plate member. In case the lens shaping element is arranged on the membrane and the frame structure below the membrane, the circumferential edge of the lens shaping element preferably has an inner diameter that is smaller than an inner diameter of the corresponding first recess of the frame structure.

According to a further embodiment, the lens shaping element is formed out of silicon (e.g. out of a silicon wafer material), particularly crystalline silicon. This allows one to achieve a very good flatness of the shaper reducing the wavefront error such as astigmatism or coma that is a consequence of a bended lens shaping element. The silicon material can be partly etched using stop layers or defined etching times and lithographic masks to create e.g. channels. Particularly, in an embodiment, at least a portion of said channel connecting the lens volume and the reservoir volume is etched into the top sheet.

According to yet another aspect of the present invention, an optical device is disclosed, wherein the optical device comprises a lens according to the present invention.

According to an embodiment of the optical device, the optical device comprises a lens barrel comprising a circumferential wall surrounding an internal space of the lens barrel, wherein at least one rigid lens (or a plurality of rigid lenses) is arranged in said internal space of the lens barrel, and wherein the circumferential wall of the lens barrel comprises a first slot configured to receive the container of the lens in an insertion direction extending perpendicular to the optical axis of the lens and in a form fitting manner such that said area of the membrane of the lens faces the at least one rigid lens of the lens barrel (i.e. an optical axis of the container is aligned with an optical axis of the lens barrel). According to a preferred embodiment, the lens shaping element of the lens is configured to protect said area of the membrane of the lens upon insertion of the container of the lens into the first slot of the lens barrel. Particularly, the first slot can also be arranged at an end of the lens barrel adjacent an opening the lens barrel at said end of the lens barrel. Here, particularly, the first slot can be formed by a recess of the circumferential wall of the lens barrel at the end of the lens barrel.

Particularly, the first slot of the lens barrel is configured to receive the container of the lens in a form fitting manner such that light can pass the lens barrel through the at least one rigid lens and the container of the lens via said area of the membrane of the lens, the fluid in the lens volume and the bottom wall of the container of the lens.

Particularly, the lens is configured to be fixed to the lens barrel by gluing it to the lens barrel, wherein particularly the first slot allows a mechanical play of the lens with respect to the lens barrel when the lens is inserted in the first slot. This allows aligning of the lens with respect to the lens barrel before final fixation of the lens with respect to the lens barrel, which ensures achieving a high optical quality (manufacturing tolerances).

Furthermore, according to an embodiment, when the container is inserted into the slot of the lens barrel in said direction, the piston structure connected to the elastically deformable wall member is arranged outside the lens barrel (and thus allows easy installation of the actuator)

Particularly, according to an embodiment, the lens barrel comprises one of: a square, rectangular or circular cross-section (particularly perpendicular to the optical axis of the lens barrel).

Furthermore, according to an embodiment, the lens barrel (particularly the circumferential wall) comprises the shape of a cuboid or a cylindrical shape.

According to a further embodiment of the optical device, the optical device is an optical zoom device and comprises a further lens according to the present invention (i.e. as stated in one of the claims 1 to 44),

Here, according to an embodiment, the circumferential wall of the lens barrel comprises a second slot configured to receive the container of the further lens in an insertion direction extending perpendicular to the optical axis of the lens and in a form fitting manner such that said area of the membrane of the further lens faces the at least one rigid lens of the lens barrel (i.e. an optical axis of the further lens is aligned with an optical axis of the lens barrel) and/or said area of the membrane of the further lens (when the container of the further lens is inserted in the second slot), wherein the lens shaping element of the further lens is configured to protect said area of the membrane of the further lens upon insertion of the container of the second lens into the second slot of the lens barrel.

Particularly, the second slot of the lens barrel is configured to receive the container of the further lens in a form fitting manner such that light can pass the lens barrel through the at least one rigid lens and the container of the further lens via said area of the membrane of the further lens, the fluid in the lens volume of the further lens and the bottom wall of the container of the further lens.

Furthermore, according to an embodiment, when the container of the further lens is inserted into the second slot of the lens barrel in said insertion direction, the piston structure of the further lens connected to the elastically deformable wall member of the further lens is arranged outside the lens barrel (and thus allows easy installation of the further actuator). Particularly, the second slot can be arranged at an end of the lens barrel adjacent to an opening the lens barrel at said end of the lens barrel. Here, particularly, the second slot can be formed by a recess of the circumferential wall of the lens barrel at the end of the lens barrel. The first slot can be arranged further away from said opening/first slot.

Furthermore, the lens according to the present invention can be used for a variety of different applications such as
optical zoom camera module (two or more lenses according to the present invention, see also above);
adjustable telescope, beam expander, collimator (two or more liquid lenses);
auto focus (AF) for cameras (tele, wide angle, folded tele, etc.);
macro focusing for cameras (tele, wide angle, folded tele, etc.);
microscope with continuous magnification, autofocus, constant working distance (two or more lenses according to the present invention);
IOT vision with autofocus, optical zoom, macro (bar code readers, machine vision, etc.);
laser projection with different working distance (fast auto focus).

Advantageously, the lens according to the present invention allows very large optical power ranges from +/−100dpt to even +/−200dpt, which is very beneficial, particularly in case such lenses are used in an optical zoom device.

In the following, further features as well as embodiments of the present invention are described with reference to the Figures that are appended to the claims, wherein:

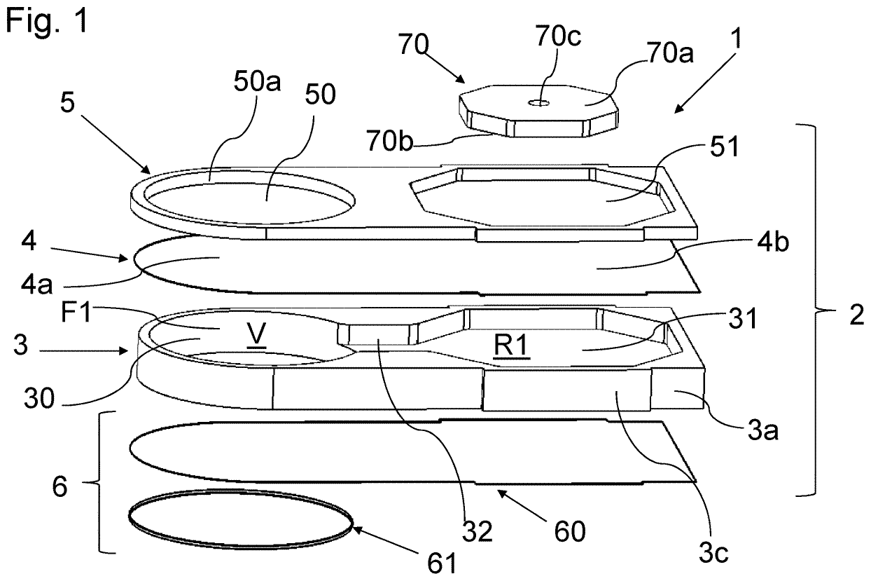

FIG. 1 shows an exploded view of an embodiment of a lens according to the present invention;

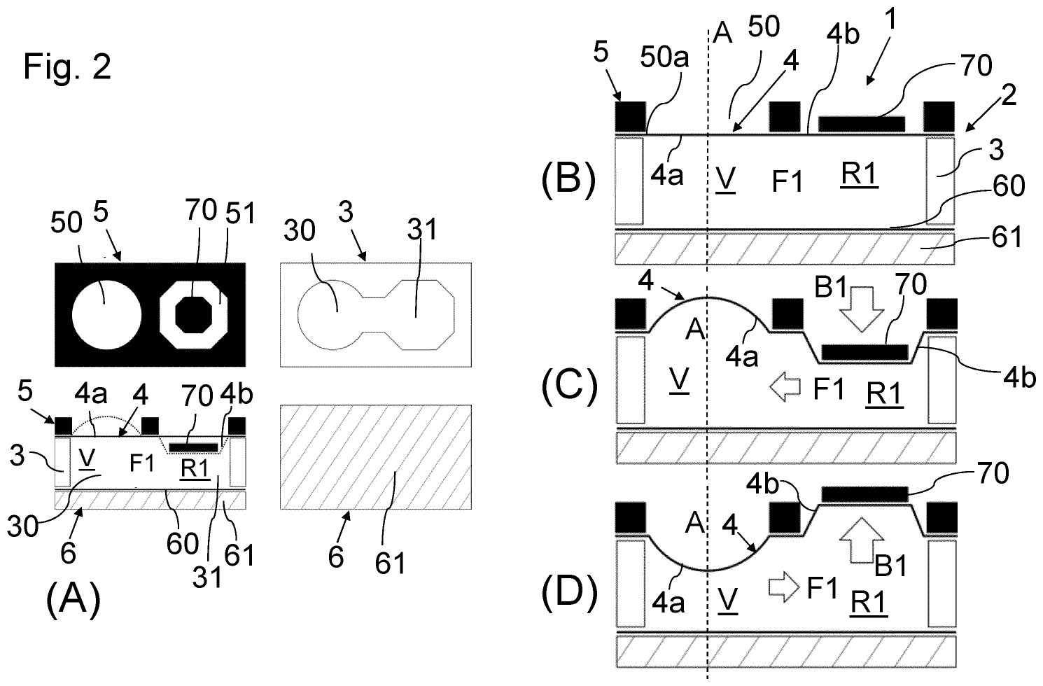

FIG. 2 shows the principle of adjusting the optical power of a lens according to the present invention, wherein (A) shows a schematical cross-section of an embodiment of the lens as well as components of the container of the lens, (B) shows an initial optical power of the lens, (C) and (D) show different deflections of the area of the membrane corresponding to different optical powers of the lens;

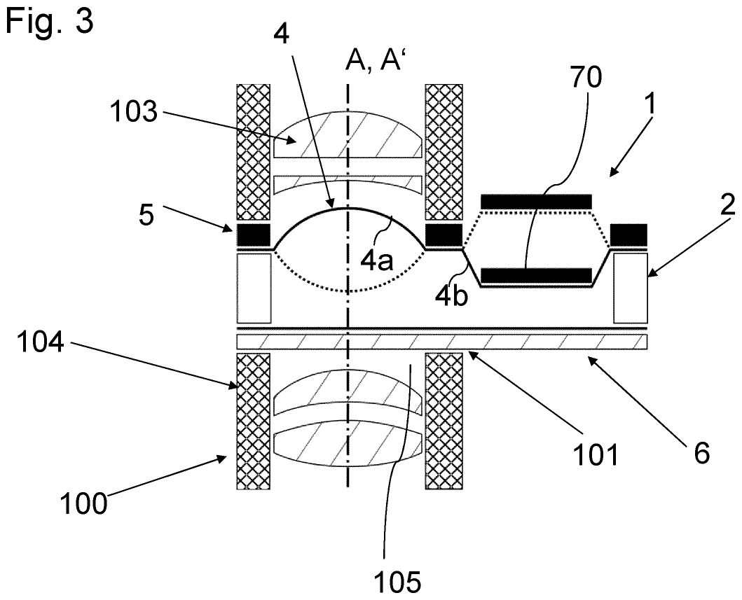

FIG. 3 shows a schematical cross-section of an embodiment of the lens inserted into a lens barrel comprising a plurality of rigid lenses to demonstrate protection of the membrane of the lens by means of the lens shaping element of the lens;

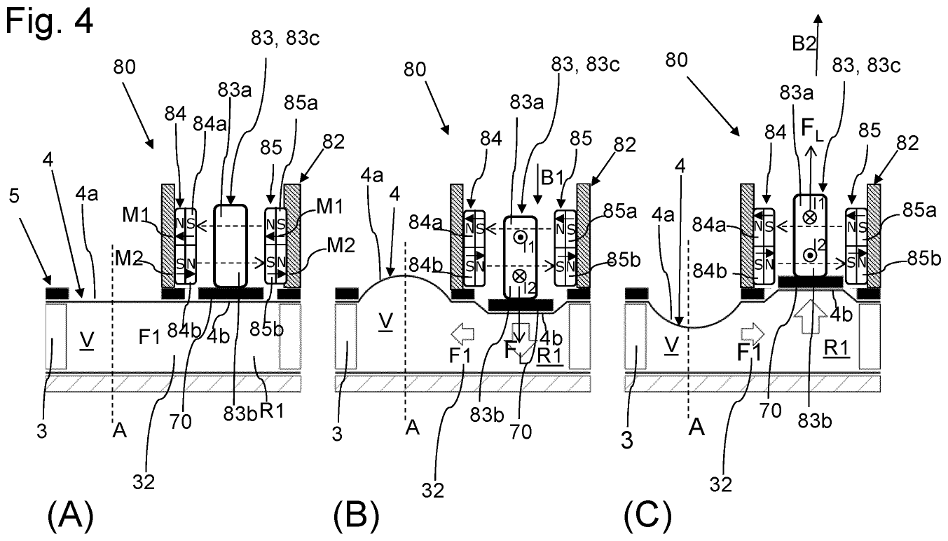

FIG. 4 shows an embodiment of an actuator of a lens according to the present invention, wherein (A) shows an initial optical power state, and (B) and (C) show different deflections of the area of the membrane of the lens corresponding to different optical powers of the lens;

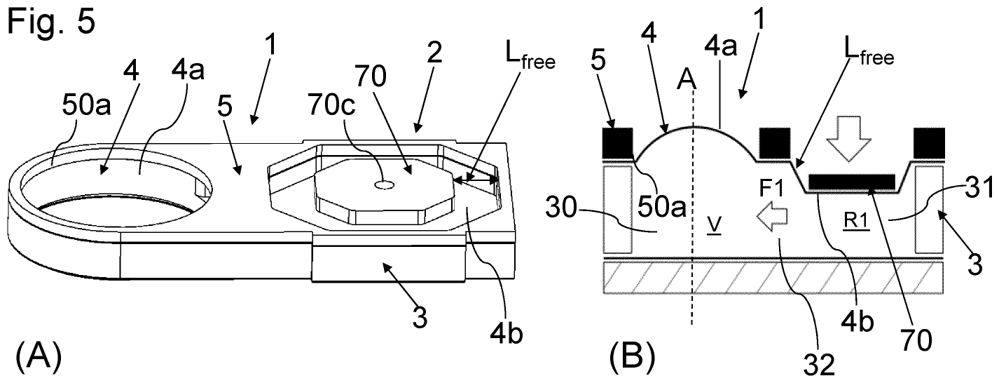

FIG. 5 shows a perspective view (A) and a schematical cross-sectional view (B) showing the free (membrane) length of a deformable wall member that is deformable by a piston structure to pump the fluid of the lens from the reservoir volume to the lens volume and vice versa;

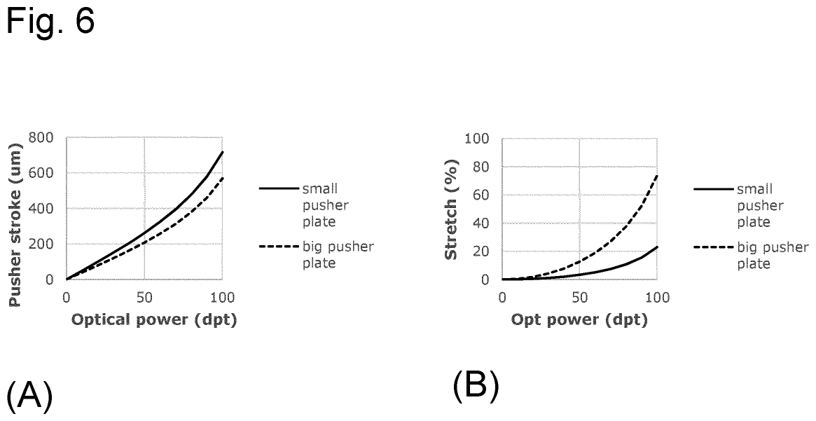

FIG. 6 shows the optical power vs. the stroke of the piston structure (pusher stroke) (A), and the optical power vs. the stretch of the membrane (stretch) (B);

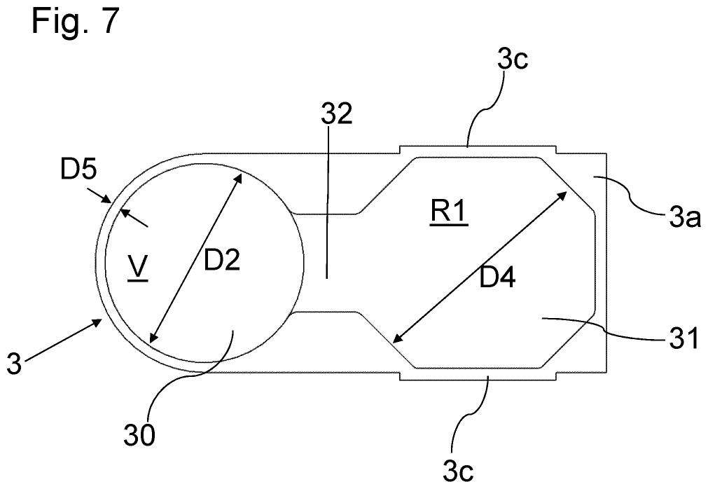

FIG. 7 shows a top view onto the frame structure of the embodiment of the lens according to the present invention as shown in FIG. 1;

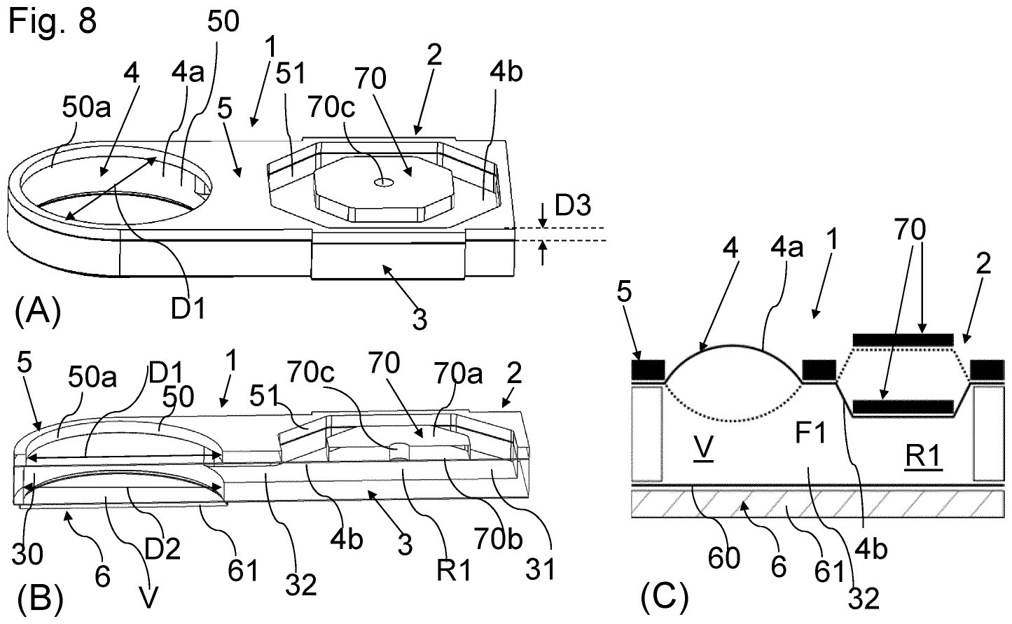

FIG. 8 shows a perspective view (A), a cross-sectional view (B), and a schematical cross sectional view (C) of the embodiment shown in FIG. 1 to demonstrate a preferred dimension of the edge of the lens shaping element with respect to the diameter of the lens volume enclosed by the frame structure;

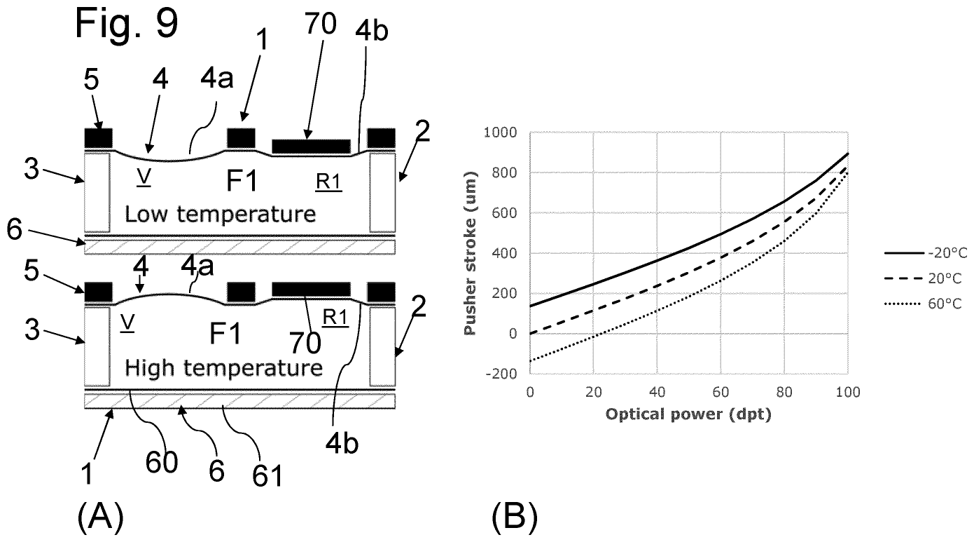

FIG. 9 shows schematical cross-sections of an embodiment of the lens for two different temperatures (A) to demonstrate the dependence of the optical power (optical power) on the temperature of the fluid (B);

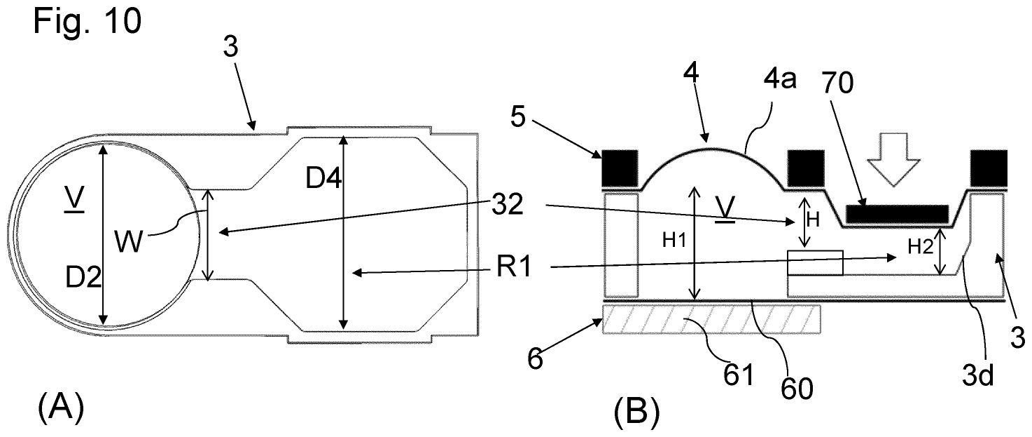

FIG. 10 shows a top view of the frame structure of a lens according to the present invention (A) and a schematical cross-sectional view of the lens comprising a reduced total volume to balance the thermal volume expansion effect against the refractive index change effect;

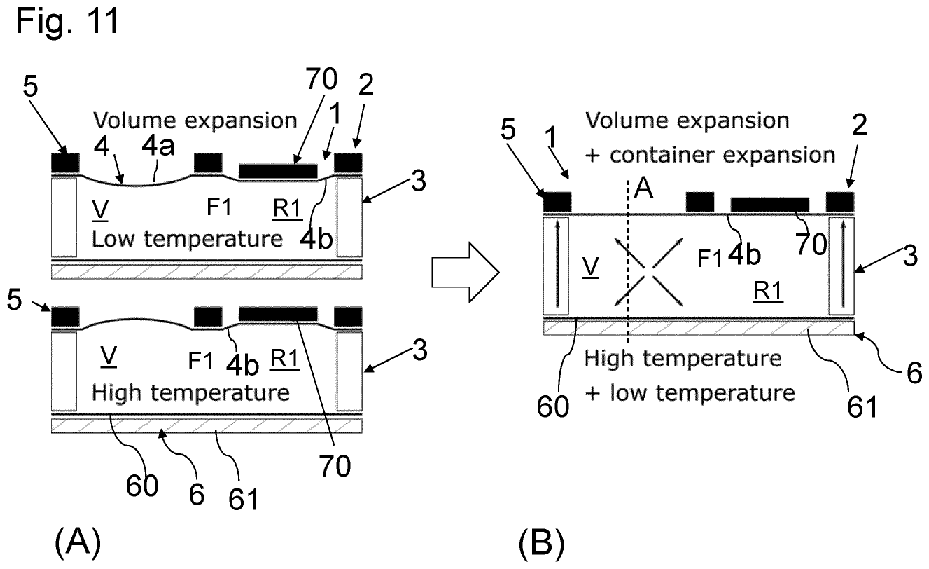

FIG. 11 shows a possibility to compensate a thermal drift of the optical power (A) using a frame structure that expands with temperature (B) so as to compensate a thermally induced increase in the volume of the fluid of the lens;

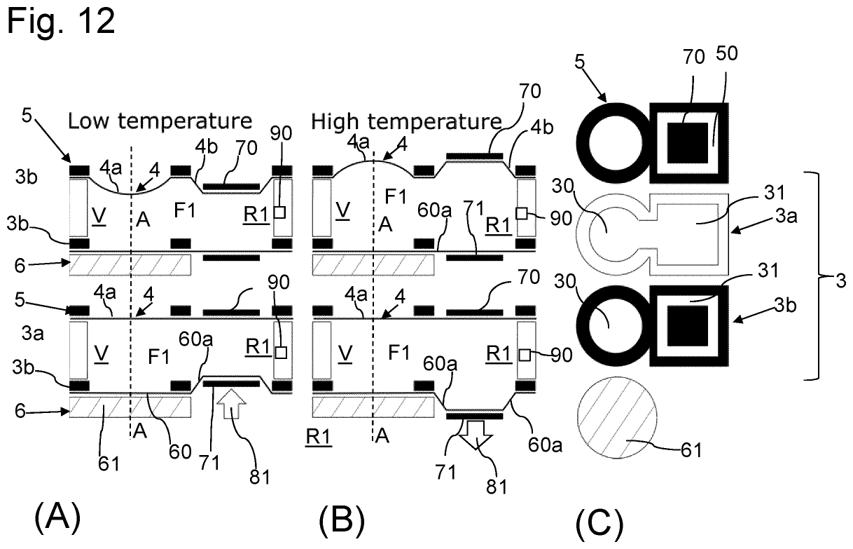

FIG. 12 shows an embodiment of a lens according to the present invention, wherein here the thermal drift in the optical power of the lens can be compensated in an active fashion using a compensation actuator, wherein (A) shows the compensation actuator correcting the optical power for low temperatures, and (B) shows the compensation actuator correcting the optical power for high temperatures. Further, (C) shows individual components of the lens;

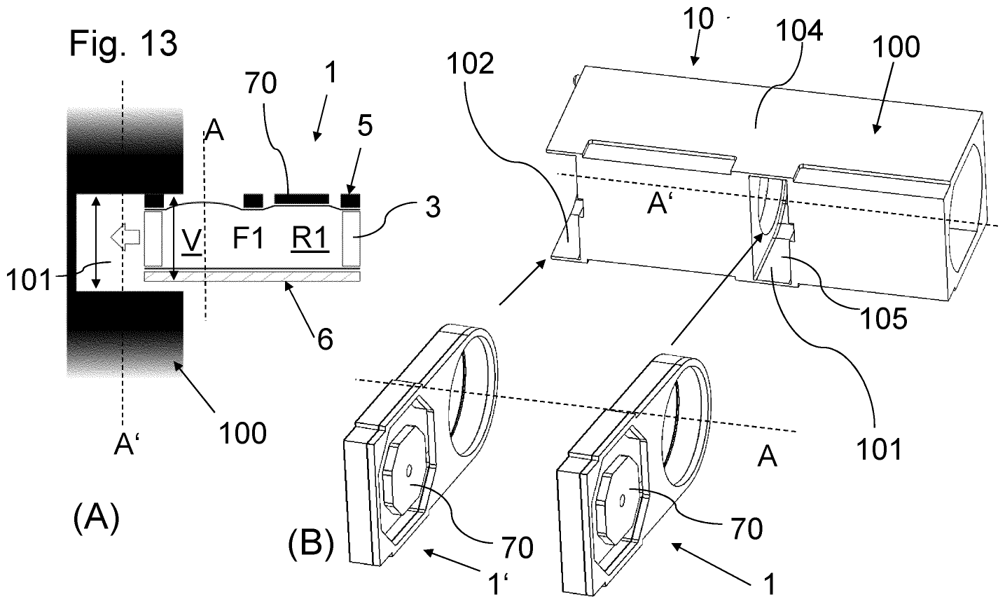

FIG. 13 shows insertion of one or two lenses according to the present invention into a lens barrel according to an embodiment of the present invention;

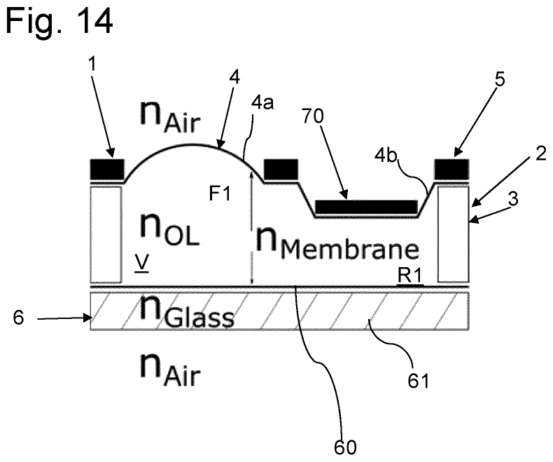

FIG. 14 shows a preferred index matching according to an embodiment of the lens according to the present invention;

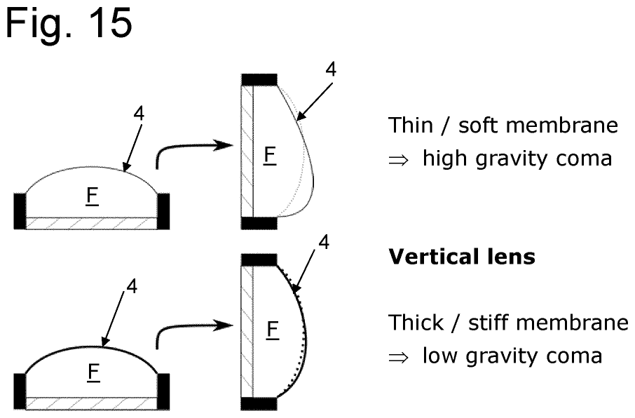

FIG. 15 demonstrates the effect of gravity-induced coma aberration in a liquid lens, wherein said aberration can be reduced using a stiffer membrane according to an embodiment of a lens according to the present invention;

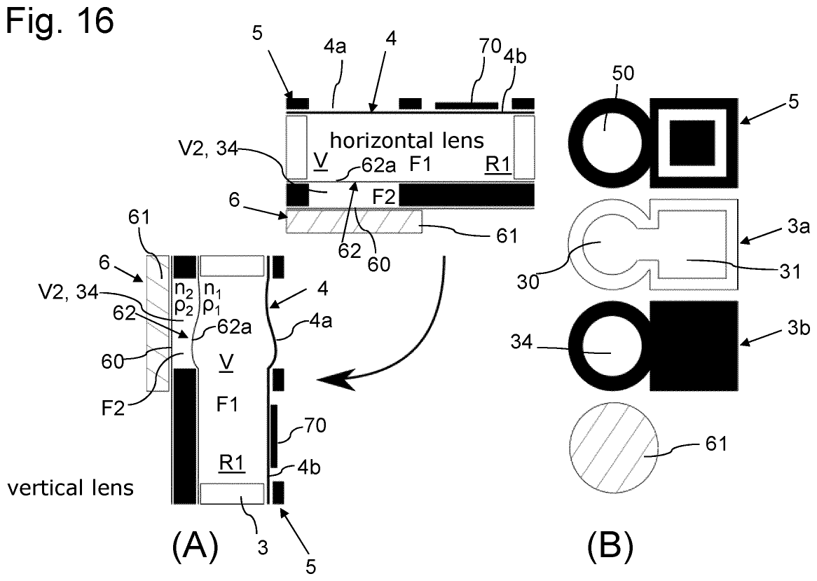

FIG. 16 shows an embodiment of a lens according to the present invention comprising a further lens volume filled with a further fluid (e.g. liquid) for compensating a gravity-induced coma aberration;

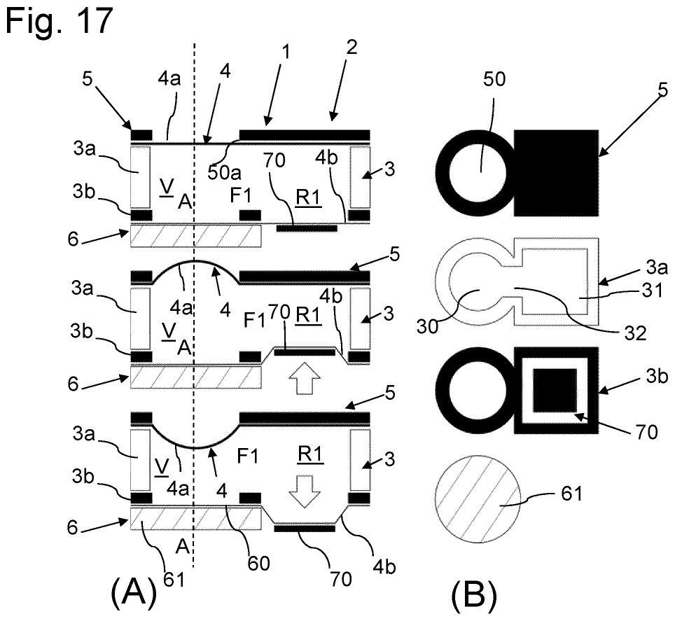

FIG. 17 shows an alternative embodiment of a lens according to the present invention, wherein (A) shows different states of the optical active area of the membrane of the lens, and (B) shows individual components of the container of the lens;

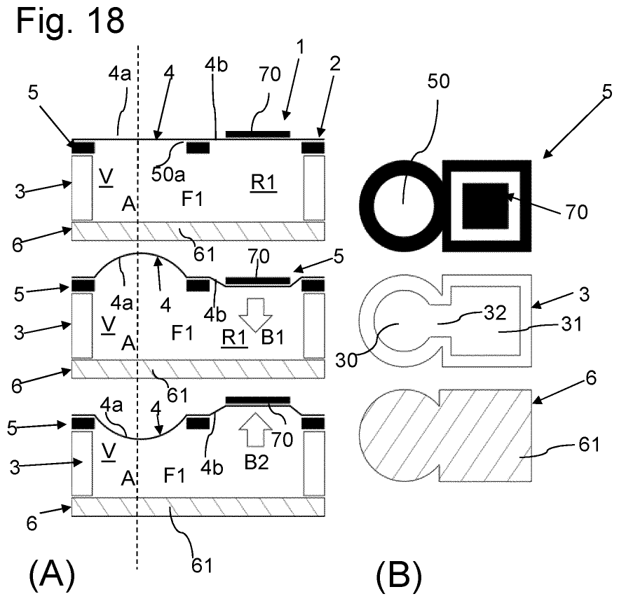

FIG. 18 shows a further alternative embodiment of a lens according to the present invention, wherein (A) shows different states of the optical active area of the membrane of the lens, and (B) shows individual components of the container of the lens; and

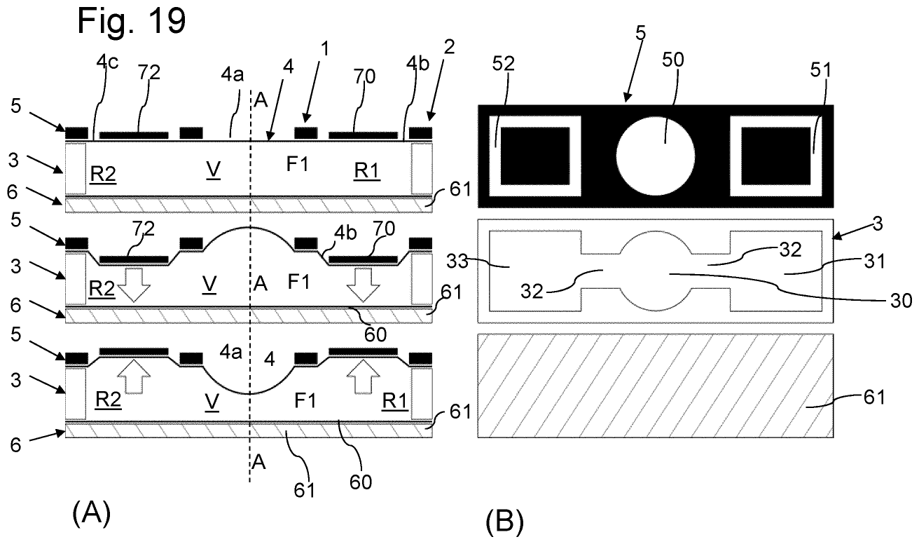

FIG. 19 shows a further alternative embodiment of a lens according to the present invention, wherein (A) shows different states of the optical active area of the membrane of the lens, and (B) shows individual components of the container of the lens.

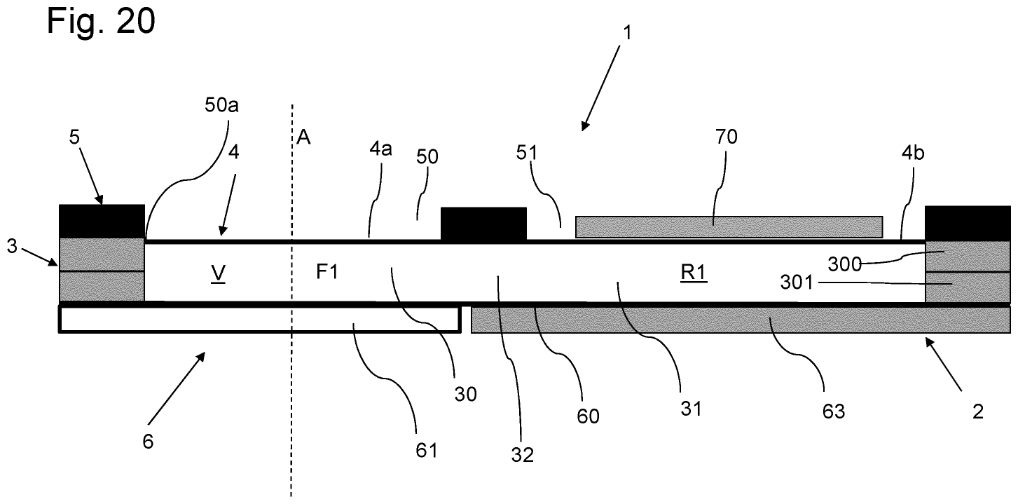

FIG. 20 shows an embodiment of a lens according to the present invention, wherein the frame structure of the lens comprises multiple sheets;

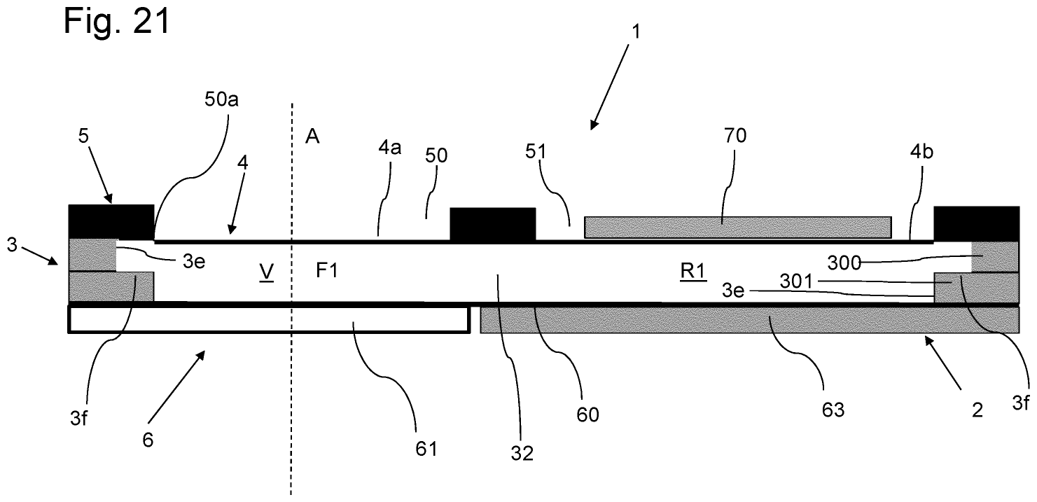

FIG. 21 shows a variant of the embodiment shown in FIG. 20, wherein the sheets form a step on an inside of the frame structure;

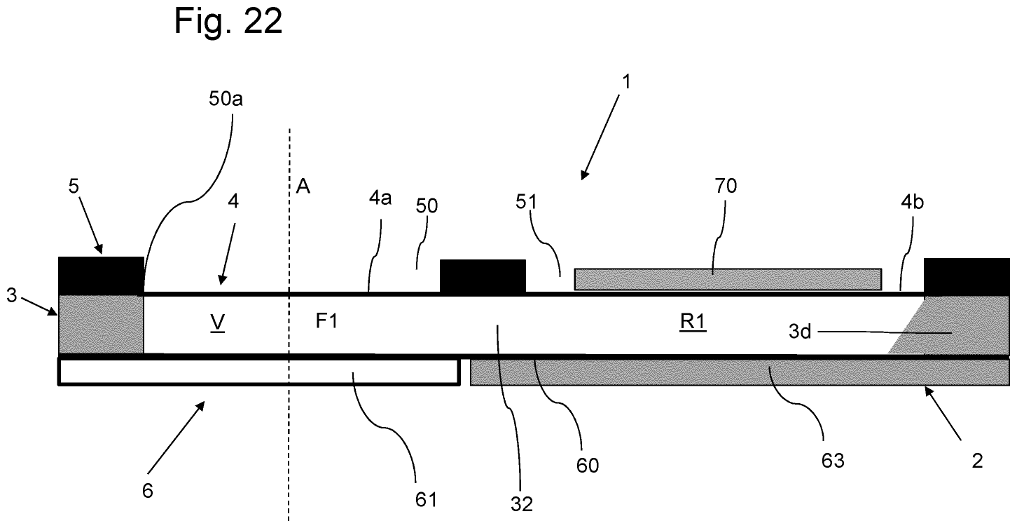

FIG. 22 shows an embodiment of a lens according to the present invention, wherein the reservoir volume delimited by the frame structure comprises a tilted inside;

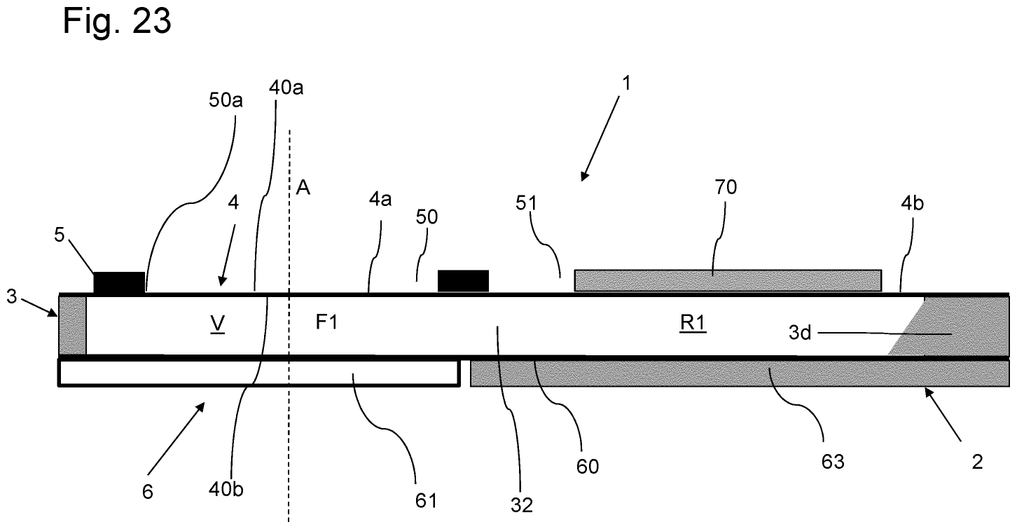

FIG. 23 shows an embodiment of a lens according to the present invention, wherein the lens shaping element is formed as a ring member that is attached to an exterior side of the membrane of the lens; and

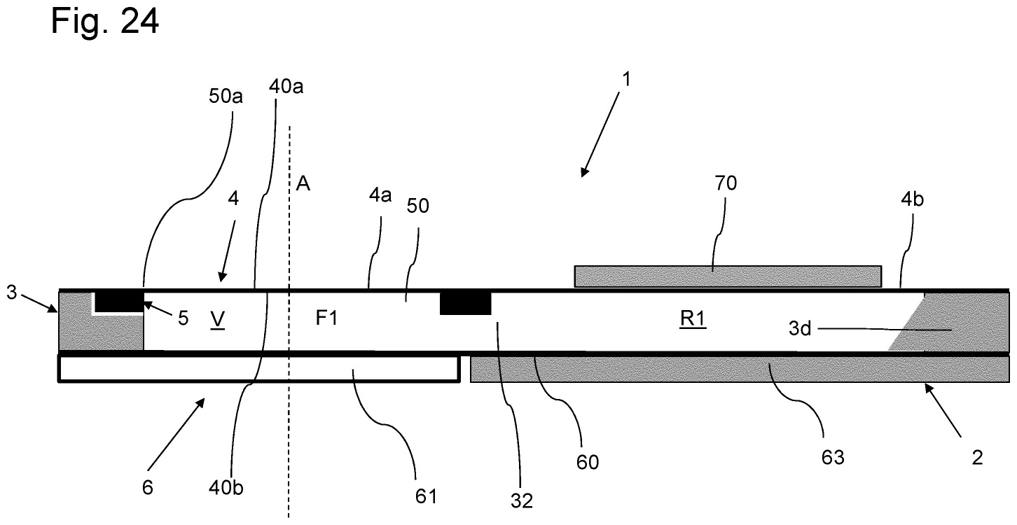

FIG. 24 shows an embodiment of a lens according to the present invention, wherein the lens shaping element is formed as a ring member that is attached to an interior side of the membrane of the lens.

FIG. 1 shows an embodiment of a lens 1 according to the present invention, particularly for use in an optical zoom device. Particularly, the lens 1 comprises a preferably flat and elongated (e.g. cuboid) container 2. The container 2 comprises a lens volume V filled with a transparent fluid (e.g. an incompressible transparent liquid) F1, a reservoir volume R1 filled with the transparent fluid F1 and connected to the lens volume V (e.g. via a channel 32), a frame structure 3 forming a lateral wall of the container 2, wherein the frame structure 3 comprises a first recess 30 in the form of a through-opening for accommodating at least a portion of the lens volume V, and wherein the frame structure 3 comprises a second recess 31 (e.g. in the form of a through-opening) for accommodating at least a portion of the reservoir volume R1. Particularly, as shown in FIG. 1, the frame structure is formed as a monolithic plate member (e.g. in form of an injection molded part), but may also be formed out of several parts (e.g. a stack of e.g. metallic sheets).

Furthermore, the container 2 comprises an elastically deformable and transparent membrane 4 connected to the frame structure 3, a lens shaping element 5 connected to the membrane 4, wherein the lens shaping element 5 comprises a circumferential (preferably circular) edge 50a defining an area 4a of the membrane 4 having an adjustable curvature, an at least partially transparent bottom wall 6 connected to the frame structure 3 so that the lens volume V is arranged between said area 4a of the membrane 4 and said bottom wall, and an elastically deformable wall member 4b adjacent the reservoir volume R1.

Particularly, the lens 1 comprises a further transparent and elastically deformable membrane 60 connected to the frame structure 3 on an opposite side with respect to the membrane 4, wherein the further membrane 60 is comprised by the bottom wall 6.

Furthermore, the bottom wall 6 may comprises a transparent rigid plate 61 arranged on the further membrane 60, so that the further membrane 60 is arranged between the frame structure 3 and the rigid plate 61 that may comprise a circular shape.

Advantageously, the membranes 4, 60 form interfaces between the respective components and act as a mechanical buffer, respectively.

Furthermore, different thermal expansion coefficients of materials on both sides of the respective membrane 4, 60 are buffered during temperature changes by the flexible membrane layers 4, 60. Furthermore, the respective membrane 4, 60 helps to absorb shocks (e.g in case of dropping of the lens). Finally, the respective membrane 4, 60 may help to achieve a well-defined distance between the individual components.

Particularly, as shown e.g. in FIG. 1 the lens shaping element 5 is formed as a flat plate and comprises a first (e.g. circular) through-opening 50 forming said circumferential edge 50a, wherein the first through-opening 50 is closed by said area 4a of the membrane 4.

According to a preferred embodiment, the membrane 4 is arranged between the frame structure 3 and the lens shaping element 5. This allows to protect the membrane 4 which will be described further below.

The lens 1 may be formed out of the following materials. Particularly, the piston structure 70 may be formed out of a metal (magnetic or non-magnetic) or a plastic material such as a polymer. Further, the lens shaping element 5 may be formed out of a metal (magnetic or non-magnetic), a plastic material (e.g. polymer), a glass or silicon. Furthermore, the frame structure 3 can be formed out of a metal or a plastic material (e.g. polymer), or silicon, too.

The bottom wall 6 (e.g. the transparent plate 61) may comprise an anti-reflection (AR) coating on at least one side (e.g. on an outside and/or on an inside) and/or may also comprise a lens shape (i.e. is not flat but comprises convex or concave surface).

FIG. 2 shows the working principle of adjusting the optical power of a lens 1 according to the present invention. Preferably, the lens shaping element 5 and the frame structure 3 are fixed to ensure optical alignment and a piston structure (also denoted as pusher plate) 70 is used to pump the incompressible liquid F1 from the reservoir volume into the lens volume V or vice versa. Particularly, a height of the frame structure 3 in the direction of the optical axis A defines the maximum deflection of the area 4a of the membrane 4 of the lens 1.

Particularly, for adjusting the optical power of the lens 1, the elastically deformable wall member 4b that is preferably formed by the membrane 4 according to an embodiment is configured to be deformed (e.g. starting from a flat initial state as shown in FIG. 2(B)) to pump fluid F1 from the reservoir volume R1 into the lens volume V or vice versa so that the fluid F1 acts on the area 4a of the membrane 4 accordingly and either bulges the area 4a further out to increase the optical power of the lens 1 (cf. FIG. 2 (C)) or reduces the curvature of said area 4a (when the fluid F1 is pumped from the lens volume into the reservoir volume R1) to decrease the optical power (e.g. FIG. 2(D)). Particularly, for acting on the deformable wall member 4b, the lens 1 preferably comprises the piston structure 70 that is preferably glued to said deformable wall member 4b for deforming the wall member 4b by pushing against the wall member 4b (leading to an increased optical power of the lens) or by pulling on the wall member (leading to a reduced optical power). In this fashion, the optical power of the lens 1 can be adjusted continuously.

Furthermore, as indicated in FIG. 3, the fixed lens shaping element 5 (with respect to the frame structure 3) ensures in an advantageous fashion an optical alignment with respect other components (e.g. here with a lens barrel 100) during actuation described in conjunction with FIG. 2.

Particularly, the lens shaping element 5 is fixed to the frame structure 3/container 2 and consequently in assemblies to other optical components. This means that the lens shaping element 5 and the frame structure 3 do not move or decenter when the optical power of the lens 1 changes and an alignment with other optical components is kept accurately during actuation.

Particularly, the lens 1 according to the present invention can be inserted in an easy manner into a lens barrel 100 in an insertion direction perpendicular to the optical axis A of the lens 1 (see also FIGS. 13 (A) and (B)), due to the fact that the reservoir volume R1 of the container 2 is arranged laterally next to the lens volume V of the container 2 with respect to the insertion direction. Thus, while the lens volume can be aligned with the lenses 103 of the lens barrel 100, the reservoir volume R1 and piston structure 70 is arranged outside the lens barrel 100 and allows easy mounting of an actuator 80 to be described below.

Due to the fact that the membrane 4 can be arranged between the lens shaping element 5 and the frame structure 3, as shown e.g. in FIGS. 1, 3 and 13, the membrane 4 can be efficiently protected by the lens shaping element 5 during assembly even in case an initial deflection of the area 4a is not zero. Furthermore, a backside of the lens can be protected by having the respective slot 101, 102 slightly wider than the container 2 of the respective lens 1, 1′. As a result, the respective lens 1, 1′/container 2 can be slid into the lens barrel 100 without destroying/scratching the membrane 4.

Particularly, protection of the area 4a of the membrane 4 is ensured due to the fact, that the lens shaping element 5 protrudes such from said area 4a of the membrane 4 in the direction of the optical axis A of the lens 1 that the container 2 can be inserted perpendicular to an optical axis A′ of the lens barrel 100 into an associated slot 101 of the lens barrel 100 in a form fitting manner such that the lens barrel 100 cannot contact said area 4a of the membrane 4 upon insertion of the container 2 of the lens 1 into the slot 101 of the lens barrel 100.

Furthermore, FIG. 4 shows a possible actuation principle involving an actuator 80 based on a moving coil 83 and stationary magnet structures 84, 85. However due to the beneficial design of the lens 1, any suitable actuator can be used to actuate the lens and can be assembled after having assembled the lens 1, particularly after insertion of the lens 1 into a lens barrel 100 (cf. FIGS. 3 and 13 for instance). Other possible actuators are: voice coil motor, piezo drive, screw drive, thermoactive actuator, SMA (shape memory alloy) actuator, reluctance force actuator.

Particularly, the actuator 80 is preferably fixed to the lens shaping element 5. Thus, a reference point for actuation is not influenced by a thermal drift (e.g. thermal expansion of container 2) and the actuator 80 is thermally decoupled from the lens 1 (e.g. heating from coil 83). Particularly, according to an embodiment of the present invention, the coil is spaced apart from the fluid F1. Furthermore, according to an embodiment, the fluid F1 is thermally decoupled from the coil by means of the piston structure 70.

Particularly, as shown in FIG. 4, the actuator 80 comprises a support structure 82, which may form a housing of the actuator and is preferably configured to mount the actuator to the lens shaping element 5 and/or to the frame structure 3 of the lens. For this, the frame structure 3 can comprises protrusions 3c indicated e.g. in FIGS. 1 and 7, which may engage with the support structure 82 and may thus also ensure proper positioning of the actuator 80 with respect to the piston structure 70.

Furthermore, the actuator comprises a mover 83 that is connected to the piston structure 70 and configured to be moved relative to the support structure 82 in a first motion direction B1 so that the piston structure 70 is pushed by the mover 83 against the elastically deformable wall member 4b of the container 2 to pump fluid F1 from the reservoir volume R1 into the lens volume V, and relative to the support structure 82 in a second motion direction B2 so that the mover 83 pulls on the elastically deformable wall member 4b of the container 2 through the piston structure 70 to pump fluid F from the lens volume V into the reservoir volume R1.

Particularly, the two motion directions B1, B2 point in opposite directions and are parallel to the optical axis A of the lens 1. Particularly, the mover 83 can be integrally connected to the piston structure 70 or engages with the hole 70c of the piston structure 70.

Particularly, when the mover 83 pushes the piston structure 70 against the wall member 4b, the latter develops a dent and thus pushes fluid F1 out of the reservoir volume R1 into the lens volume V such that said area 4a of the membrane 4 of the lens 1 develops a corresponding convex shape and the optical power of the lens 1 increases. Further, when the mover 83 pulls on the piston structure 70, the latter pulls on the wall member 4b which then bulges outwards and thus pumps fluid F1 from the lens volume V to the reservoir volume R1 such that the convex curvature of the area 4a of the membrane 4 of the lens 1 and therewith the optical power decreases. Any intermediary deflection state between the states shown in FIGS. 4(B) and 4(C) can thus be realized in a continuous fashion.

Particularly, the mover 83 comprises an electrical coil 84, wherein the electrical coil comprises a first portion 84a in which an electrical current generated in the coil 84 flows in a first current direction I1, and wherein the electrical coil 84 comprises a second portion 84b in which the electrical current generated in the coil 84 flows in a second current direction I2 that is opposite the first current direction I1.

Further, the actuator 80 comprises a first and a second magnet structure 84, 85 which are mounted to the support structure 82 such that the coil 83 is arranged between the two magnet structures 84, 85, wherein each magnet structure 84, 85 comprises a first portion 84a, 85a having a first magnetization M1 and a second portion 84b, 85b having a second magnetization M2 that is opposite the first magnetization M1. The magnet structures 84, 85 can be assembled from separate magnets or may be magnetized to receive said magnetizations M1, M2.

Furthermore, as shown in FIG. 4(A), the first portion 84a of the first magnet structure 84 faces the first portion 85a of the second magnet structure 85, and wherein the first portion 83a of the coil 83 is arranged between the first portion 84a of the first magnet structure 84 and the first portion 85a of the second magnet structure 85, and wherein the second portion 84b of the first magnet structure 84 faces the second portion 85b of the second magnet structure 85, and wherein the second portion 83b of the coil 83 is arranged between the second portion 84b of the first magnet structure 84 and the second portion 85b of the second magnet structure 85.

This arrangement allows one to achieve that the first magnetizations M1 of the first portions 84a, 85a of the magnet structures 84, 85 extend essentially perpendicular to the first current direction I1, and that the second magnetizations M2 of the second portions 84b, 85b of the magnet structures 84, 85 extend essentially perpendicular to the second current direction I2 such that a Lorentz force acts on each portion 83a, 83b of the coil 83 when an electrical current flows through the electrical coil 83, which Lorentz forces move the mover 83 in the first motion direction B1 or in the second motion direction B2 depending on the orientation of the first and second current direction I1, I2 (i.e. the polarity of the electrical coil).

Furthermore, FIG. 5 shows how the reservoir volume's R1 shape can be selected so as to reduce the force of the actuator (e.g. 80) that is necessary to deform the deformable wall member 4b by a certain amount. Particularly, the force can be reduced by selecting a suitable free membrane length L_{free}, wherein the shape of the piston structure 70 is preferably designed so as to prevent high stress on free membrane area to minimize the risk of membrane rupture. Particularly, increasing L_{free} reduces the force and increases the stroke.

An ideal shape to achieve stress reduction would be a round pusher plate 70 and a round reservoir volume V. However, an octagonal shape of the reservoir volume and bottom surface 70b of the piston structure as shown in FIG. 5 allows to achieve a comparatively large reservoir volume size for a relatively low membrane stress together with minimal outer dimensions of the frame structure 3. This is beneficial to optimize the optical power range of the lens 1 for the same outer dimensions and available actuator force.

Thus, according to an embodiment, the piston structure 70 is preferably formed by a plate comprising an octagonal bottom surface 70b for acting on the wall member 4b/membrane 4 The top surface 70c may also comprise an octagonal shape. Furthermore, the reservoir volume R1 preferably comprises an octagonal cross-sectional area parallel to said bottom surface 70b of the plate/piston structure 70.

FIG. 6 illustrates the optimal size of the piston structure's 70 bottom surface 70b to reduce the actuator force.

Particularly, the left-hand side of FIG. 6 shows the optical power (optical power) vs. stroke of the piston structure 70 in the motion directions B1, B2 (pusher stroke). According thereto, in case of a big surface 70b only a rather small stroke is necessary to reach a specific optical power. This however requires a larger actuator force (lens 1 can be thinner).

In case of a smaller surface 70b, a rather big stroke is necessary to reach a specific optical power which requires a larger container height (actuator can be weaker).

Furthermore, the right-hand side illustrates the optical power (optical power) vs. the stretch of the area 4a of the membrane 4 (stretch).

According thereto, a big surface 70b pusher plate results in a short free membrane (L_{free}) and a high stretch on the membrane area 4a and thus a high force.

These relations allow for finding an optimum between travel and actuator force given certain design parameters. Particularly, a small surface 70b results in a low force, a long travel, and a high frame structure 3/container 2. On the other hand, a big surface 70b results in a high force, a short travel and a comparatively low container/frame structure height.

As shown in the embodiment of FIG. 7, the specific design of the frame structure 3/container 2 of the lens 1 allows to achieve a maximal clear aperture while having minimal outer dimensions. This is beneficial since the minimal outer dimensions allow to reduce footprint and save space, while at the same time the maximal clear aperture ensures a good optical quality. The maximal pump reservoir size allows to reduce stretch on the membrane 4 (less force required by actuator). The frame structure 3 shown in FIG. 7 can be produced by injection molding, machining, laser cutting or stacking of metal sheets. Particularly, the lens volume comprises a circular cross section having a diameter D2 while the frame structure comprises a curved outer wall at an end of the frame structure to achieve a constant wall thickness D5 along at least a section of the lens volume V. Further, the lens volume is connected via a channel 32 of the frame structure 3 to the reservoir volume R1 having a (e.g, diagonal) diameter D5 that is larger than said diameter of the lens volume. Particularly, the reservoir volume R1 comprises an octagonal shape.

As further illustrated in FIG. 8, the specific design of the lens shaping element as a flat plate comprises a circular through-opening 50 and a circular edge 50a thereof, allows to precisely define the shape/boundary of the area 4a of the membrane that is used to tune the optical power of the lens 1 (by giving it corresponding, e.g. spherical, curvatures). Particularly, as an example, the diameter D1 can be 5 mm. Further, as an example, the thickness D3 can be 0.3 mm.

Particularly, the lens shaping element 5 is capable of defining the shape of the lens with a desired wavefront error that is smaller than 0.2 rms lambda @530 nm. Preferably, the recess 50 comprises a roundness that is smaller 50 μm to achieve a minimal astigmatism. Furthermore, the edge 50a comprises a flatness that is preferably smaller than 2 μm peak to valley, which also allows to achieve minimal astigmatism. Particularly, the lens shaping element 5 can be fabricated from a metal of from other flat sheet materials.

Furthermore, in order to ensure a proper boundary condition for the area 4a of the membrane 4, the first recess 30 of the frame structure 3 comprises an inner diameter D2 that is preferably larger than an inner diameter D1 of the (co-axial) circumferential edge 50a of the first through-opening 50 of the lens shaping element 5.

Furthermore, as indicated in FIG. 9 the refractive index of the fluid F1 decreases with increasing temperature leading to a decreasing optical power of the lens with increasing temperature. Furthermore, the volume of optical fluid (e.g. liquid) F1 increases with increasing temperature leading to an increasing optical power with increasing temperature.

Thus, for the same initial optical power, the lens 1 needs a different actuator stroke at higher or lower temperatures to reach the full tuning range of the lens 1. Such a drift may be compensated by the actuator 80 to recover the initial optical power state.

According to the embodiment shown in FIG. 10 temperature-induced changes in the optical properties of the lens 1 may also be reduced using proper dimensions for the lens volume and reservoir volume V, R1 of the lens 1.

Particularly, to balance a volume expansion effect against the refractive index change effect, the total volume V, R1 of the lens 1 can be minimized. This can be achieved by providing tilted side walls 3d in the container 2 to reduce the total volume. Furthermore also a reduction of the liquid channel's 32 volume between the reservoir volume and the lens volume can be used. Such a reduction of the channel's volume is made such that a proper actuation speed of the liquid lens (friction) can be maintained (the smaller the channel, the smaller the actuation speed). As a result, actuation speed and thermal drift of the liquid lens can be tuned.

Particularly, for balancing an increase in optical power of the lens 1 due to an increase of the volume of the fluid F with increasing temperature and a decrease of the optical power due to a decrease of the refractive index of the fluid F1 with increasing temperature, the reservoir volume R1 is delimited by a tilted inside 3d of the second recess 31 of the frame structure 3 according to an embodiment so as to reduce the reservoir volume. Further the channel 32 providing a flow connection between the lens volume V and the reservoir volume R1 is given a height H along the optical axis A of the lens 1 such that the height H is smaller than a height H1 of the lens volume V and/or than a height H2 of the reservoir volume R1 along the optical axis A of the lens 1 to support/achieve said balancing. Furthermore, the channel 32 can be given a width W perpendicular to the optical axis A of the lens 1 that is smaller than a diameter D4 of the reservoir volume R1 and/or than a diameter D2 of the lens volume V to achieve/support said balancing.

Furthermore, as shown in FIG. 11, the container 2 of the lens 1 may be configured to provide a passive temperature drift compensation of the optical power of the lens 1. According thereto, the material of the frame structure 3 can be chosen such (e.g. a suitable plastic material) with respect to the fluid F1 material that the frame structure 3 comprises a sufficiently high thermal expansion coefficient. Then, the frame structure can expand with temperature such that the expansion of optical fluid F1 is compensated and the deflection state of the area 4a of the membrane 4 can be maintained.

Particularly, according to an embodiment, the frame structure 3 is configured to expand predominantly along the optical axis A of the lens with increasing temperature to reduce a change in the optical power of the lens 1 due to an increase of the volume of the fluid F1 with increasing temperature and particularly also due to a decrease of the refractive index of the fluid F1 with increasing temperature.

As an alternative to the passive compensation scheme described in conjunction with FIG. 11, also a compensation actuator 81 can be used to achieve an active temperature compensation as shown in FIG. 12. Particularly, the compensation actuator 81 acts on the same reservoir volume R1. While the actual actuator 80 tunes the optical power, the compensation actuator 81 ensures that a certain initial optical power state is maintained in case the temperature of the lens 1 changes.

Particularly, the compensation actuator 81 is configured to recover the initial optical power state of the lens 1 using a temperature sensor 90 and a temperature calibrated drift correction actuation scheme. Particularly, the compensation actuator 81 can be a slow-moving actuator (e.g. screw drive) since thermal changes usual occur on a longer time scale. Further, the compensation actuator 81 can be thermally active actuator (e.g. negative thermal expansion material).

Particularly, according to the specific embodiment shown in FIG. 12, the container 2 comprises an elastically deformable wall region 60a adjacent the reservoir volume R1 for compensating said thermal drift of the optical power of the lens 1, wherein the compensation actuator 81 is configured to deform said elastically deformable wall region 60a to counteract the thermal drift of the optical power of the lens 1. Furthermore, the temperature sensor 90 is configured to measuring the temperature of the lens 1 (particularly of the fluid F1 in the reservoir volume R1 and/or in the lens volume V), wherein the lens 1 is configured to control the compensation actuator 81 using an output signal of the temperature sensor 90 that is indicative of said temperature to counteract the thermal drift of the optical power of the lens 1.

Furthermore, FIG. 14 illustrates an index matching and the provision of anti reflection coatings of the lens 1. Preferably, the optical fluid or liquid F1 comprises a large Abbe number to reduce optical errors and dispersion. Particularly, an anti reflection (AR) coating is provided on an outside of the membrane 4, particularly on the area 4a, to hinder multiple reflections, ghosting, and flair.

Furthermore, an index matching between the membrane 4 and the fluid F1 (OL) can be provided as well as an index matching from the optical fluid or liquid F1 to the membrane 60 to the plate 61 (e.g. glass) (membrane supports refractive index of optical fluid/liquid F1 and glass).

Furthermore, an anti-reflection coating is preferably also provided on an outside or both sides of the plate (e.g. glass) 61.

Particularly, the fluid F1 comprises a refractive index (n_{OL}) in the range from 1.2 to 1.4, and/or wherein the transparent and elastically deformable membrane 4 or 60 (n_{membrane}) comprises a refractive index in the range from 1.3 to 1.6, and/or wherein the transparent rigid plate 61 (of the bottom wall 6) comprises a refractive index (n_{glass}) in the range from 1.4 to 1.6.

Furthermore, FIG. 15 illustrates gravity effects that can be encountered when using liquid lenses 1. Particularly, the shape of the lens 1 is defined by the gravity acting on the optical liquid/fluid F1 and the membrane 4. In case the lens 1 is now tilted to a vertical state (horizontal optical axis) the fluid F1 sags and leads to a coma type aberration (gravity coma). Therefore, a thin/soft membrane 4 leads to high gravity coma, while a thick/stiff membrane 4, reduces the gravity coma.

Therefore, according to an embodiment of the present invention, the membrane 4 forming said area 4a of the lens 1 comprises a larger thickness than a further membrane 60 of the lens to reduce a gravity-induced coma aberration of the area 4a of the membrane 4. The thinner membrane 60 can now be used to tune the lens 1 as e.g. shown in conjunction with FIG. 17.

Particularly, according to the embodiment shown in FIG. 16, two optical liquids/fluids F1, F2 can be used for coma compensation. Particularly, in this embodiment, two different optical liquids/fluids F1, F2 are separated by thin separating membrane 62, wherein the refractive indices, volumes and densities of these fluids F1, F2 as well as thicknesses/stiffnesses of both membranes 4, 62 are optimized to reduce the gravity coma.

Particularly, as shown in FIG. 16, the container 2 encloses a further lens volume V2 filled with the further transparent (coma correction) fluid F2, wherein the further lens volume V2 is separated from the lens volume V by said transparent and elastically deformable separating membrane 62, such that the further fluid F2 is arranged between the fluid F1 of the lens volume V and the bottom wall 6, wherein for at least partially compensating a gravity-induced coma aberration of said area 4a of the membrane 4, the further fluid F2 comprises a density ρ₂ and a refractive index n₂, wherein the density ρ₂ of the further fluid F2 is smaller than a density ρ₁ of the fluid F1, and wherein the refractive index n₂ of the further fluid F2 is larger than a refractive index n₁ of the fluid F1 such that the compensation is achieved (given the material poperies of membranes 4 and 62).

Here, particularly, the frame structure 3 can comprise a first frame element 3a forming a portion of the lateral wall of the container 2, wherein the first frame element 3a forms a portion of the first recess 30 of the frame structure 3 and a portion of the second recess 31 of the frame structure 3, wherein these portions of said recesses 30, 31 are connected (e.g. via a channel 32) to provide a flow connection between the lens volume V and the reservoir volume R1 of the container 2. Furthermore, the frame structure 3 comprises an adjacent parallel second frame element 3b which comprises a recess 34 accommodating the further lens volume V2, wherein said separating membrane 62 is arranged between the first frame element 3a and the second frame element 3b. A circumferential edge of the recess 30 of the second frame element 3b defines an area 62a of the separating membrane that is configured to deform due to gravity acting on the further fluid such that the coma aberration of the area 4a of the membrane 4 is compensated. This is achieved by a suitable selection of the densities and refractive indices of the fluid F1 and the further Fluid F2 (given the membranes 4 and 62) describe above. Furthermore, particularly, the recess 33 of the second frame element 3b is covered by said bottom wall 6 of the container 2 (e.g. by further membrane 60 and rigid plate 61).

FIG. 17 shows a further alternative lens design, wherein particularly said area 4a is formed by a relatively thick membrane 4 (compared to the further membrane 60) to reduce the gravity coma, whereas a thinner further membrane 60 is used to form the pump actuation area (deformable wall member) 4b to reduce the actuation force.

Particularly, the frame structure 3 can comprise a first frame element 3a forming a portion of the lateral wall of the container 2, wherein the first frame element 3a forms a portion of the first recess 30 of the frame structure 3 and a portion of the second recess 31 of the frame structure 3, wherein these portions of said recesses 30, 31 are connected to provide a flow connection between the lens volume and the lateral volume of the container (e.g. through a channel 32). Furthermore, the frame structure 3 comprises an adjacent parallel second frame element 3b which forms a portion of the first recess 30 of the frame structure 3 and a portion of the second recess 31 of the frame structure 3, wherein these recess portions are separated. Particularly, the portion of the first recess 30 of the second frame element 3b is covered by said bottom wall 6 of the container and the portion of the second recess 31 of the second plate element 3b is covered by the elastically deformable member 4b (which forms a portion of the bottom wall 6) to which the piston structure 70 (see above) is connected. Particularly, the bottom wall 6 comprises the further membrane 60 which covers both portions of the first and the second recess 30, 31 of the second frame element 3b (and forms the elastically deformable wall member 4b of the reservoir volume R1), wherein the transparent rigid plate 61 of the bottom wall 6 covers the portion of the first recess 30 of the second frame element 3b, and wherein the further membrane 60 is arranged between the transparent rigid plate 61 of the bottom wall 6 and the second frame element 3b.

FIG. 18 shows a further alternative design of the container 2 of the lens 1. Here, instead of arranging the membrane 4 between the lens shaping element 5 and the frame structure 3 as shown e.g. in FIG. 1, the membrane 4 is arranged on top of the lens shaping element 5 so that the latter is arranged between the frame structure 3 and the membrane 4. Furthermore, the plate 61 (e.g. glass) covers the entire frame structure on the side facing away from the membrane 4. Particularly, this design allows an easy manufacturing of the container 2.

Furthermore, FIG. 19 shows a further alternative design of the container 2 of the lens 1. Here, the lens 1 comprises two reservoir volumes R1, R2 and two piston structure 70, 72 that can each be actuated by a dedicated actuator 80 (however also a single actuator may act on both piston structures 70, 72). Using two actuators (e.g. 80) can be beneficial since less force is required by individual actuator and less stroke needs to be generated by the individual actuator.

Particularly, as shown in FIG. 19, the lens 1 can comprise (e.g, in addition to the features described in conjunction with FIG. 1) a lens shaping element 5 comprising a second through-opening 51, wherein the second through-opening 51 is covered by a further elastically deformable wall member 4c (e.g. by the membrane 4).

Also here, the second through-opening 51 preferably comprises an octagonal shape. Other shapes are also possible.

Particularly, the reservoir volume R1 and the further reservoir volume R2 of the container 2 face each other in a direction perpendicular to the optical axis A of the lens 1 and are arranged on opposite sides of the lens volume V.

Particularly, the frame structure 3 of the container 2 of the lens 1 can comprise a third recess 33 for accommodating at least a portion of the further reservoir volume R2, which third recess 33 is covered by the further wall member 4c of the container 2 and particularly by the bottom wall 6 of the container 2 of the lens 1 (from the other side).

Preferably, also the lens shaping element 5 comprises a third through-opening 52, wherein the third through-opening 52 is covered by the elastically deformable wall member 4c (e.g. by the membrane 4). Particularly, the third through-opening 52 comprises an octagonal shape, too.

Furthermore, the lens 1 can comprise a further actuator (e.g. 80) that is configured to act on the further piston structure 72 connected to the wall member 4c to pump fluid F1 from the further reservoir volume R2 into the lens volume V or from the lens volume V into the further reservoir volume R2 so as to change the curvature of said area 4a of the membrane 4 and therewith the optical power of the lens 1.

Also here, the further actuator can be one of the following actuators: a voice coil motor, a piezo drive, a screw drive, a thermoactive actuator, a SMA (shape memory alloy) actuator, or a reluctance force actuator. Particularly, the further actuator acting on the further piston member 72 can be configured as the actuator 80 described above in conjunction with FIG. 4.

Finally, as shown in FIG. 13 the lens 1 according to the present invention is particularly suited for used in an optical device 10 that comprises a lens barrel 100 comprising a circumferential wall 104 surrounding an internal space 105 of the lens barrel 100, wherein at least one rigid lens 103 (or a plurality of rigid lenses) is arranged in said internal space 105 of the lens barrel 100, and wherein the circumferential wall 104 of the lens barrel 100 comprises a first slot 101 configured to receive the container 2 of the lens 1 in a form fitting manner such that said area 4a of the membrane 4 of the lens 1 faces the at least one rigid lens 103 of the lens barrel 100 (i.e. an optical axis of the container A is aligned with an optical axis A′ of the lens barrel 100), wherein the lens shaping element 5 of the lens 1 is configured to protect said area 4a of the membrane 4 of the lens 1 upon insertion of the container 2 of the lens 1 into the first slot 101 of the lens barrel 100.

Particularly, the first slot 102 of the lens barrel 100 is configured to receive the container 2 of the lens 1 in a form fitting manner (e.g. by insertion of the container 2 of the lens 1 into the slot 101 in an insertion direction that is perpendicular to the optical axis A of the lens 1 and to the optical axis A′ of the lens barrel 100) such that light can pass the lens barrel 100 through the at least one rigid lens 103 and the container 100 of the lens 1 via said area 4a of the membrane 4 of the lens 1, the fluid F1 in the lens volume V and the bottom wall 6 of the container 2 of the lens 1. Particularly, when the container 2 is inserted into the first slot 101 of the lens barrel 100, the piston structure 70 connected to the elastically deformable wall member 4b is arranged outside the lens barrel 100.

In the same way a number of lenses 1 (e.g. two or more) can be used/provided as components of an optical zoom device 10, wherein each lens 1 can be inserted into the lens barrel 100 through a corresponding slot 101, 102 while the respective membrane 4 is protected by the corresponding lens shaping element 5 as described herein. Such an optical zoom device 10 can comprise an actuator 80 for each lens 1, 1′ as described in conjunction with FIG. 4 or as claimed herein with respect to the lens 1. Advantageously, these actuators 80 can be easily mounted to the respective lens 1, 1′ when the respective lens 1, 1′ has been inserted into the lens barrel 100.

FIGS. 20 to 22 show further embodiments of a lens 1 according to the present invention.

FIG. 20 shows an embodiment of a lens 1 according to the present invention, particularly for use in a folded camera device, a tele device, or a zoom device. Particularly, as before, the lens 1 comprises a preferably flat and elongated (e.g. cuboid) container 2. The container 2 comprises a lens volume V filled with a transparent fluid (e.g. an incompressible transparent liquid) F1, a reservoir volume R1 filled with the transparent fluid F1 and connected to the lens volume V (e.g. via a channel 32), a frame structure 3 forming a lateral wall of the container 2, wherein the frame structure 3 comprises a first recess 30 in the form of a through-opening for accommodating at least a portion of the lens volume V, and wherein the frame structure 3 comprises a second recess 31 (e.g. in the form of a through-opening) for accommodating at least a portion of the reservoir volume R1. Particularly, in contrast to FIG. 1, the frame structure 3 is now comprised of multiple sheets 300, 301, here e.g. a top sheet 300 and a further sheet 301 which are arranged on top of one another.

In the modification of this embodiment shown in FIG. 21, the further sheet 301 can be formed such in relation to the top sheet 300 (for example the further sheet 301 can comprises a smaller inner diameter in the region of the reservoir volume R1 and/or in the region of the lens volume V compared to the top sheet 300) so that an internal side 3e of the frame structure 3 of the container 2 forms a step 3f.

Alternatively, as shown in FIG. 22, instead of a sheet-like structure, the frame structure can be formed by a single plate member that comprises a tilted inside 3d (for example adjacent to the reservoir volume R1). Such tilted insides 3d or steps 3f can be used to reduce the temperature dependence of the optical power of the lens 1. Furthermore, the step 3e can be used to reduce interference of the frame structure 3 with the lens shaping element 5 (cf. FIG. 21).

Furthermore, the respective container 2 shown in FIGS. 20 to 22 comprises an elastically deformable and transparent membrane 4 connected to the frame structure 3 (e.g. to the top sheet 300 in FIG. 21), a lens shaping element 5 connected to the membrane 4, wherein the lens shaping element 5 comprises a circumferential (preferably circular) edge 50a defining an area 4a of the membrane 4 having an adjustable curvature. However, the lens shaping element 5 can also be formed by a the frame structure 3, particularly by the top sheet 300, which then comprises a circumferential edge 50a that defines an area 4a of the membrane 4 having an adjustable curvature. Here, the top plate member 5 shown in FIGS. 20 and 22 then forms a protection plate member 5 arranged on top of the membrane 4 to protect the membrane 4 by having the membrane 4 arranged between the frame structure 3 and the protection plate member 5. The protection plate member 5 then further comprises a first through-opening 50 aligned with the first recess 30 to allow passage of light and a second through-opening 51 aligned with the second recess 31. Preferably, the membrane 4 is glued to the frame structure 3, particularly to a top sheet 300 of the frame structure 3.

Particularly, the respective lens shaping element 5, 3 or 300 can be formed out of silicon (e.g. out of a silicon wafer), particularly crystalline silicon. This allows one to achieve a very good flatness of the respective lens shaping element reducing the wavefront error such as astigmatism or coma that is a consequence of a bended lens shaping element. Furthermore, at least a portion of a channel 32 connecting the lens volume V and the reservoir volume R1 can be etched into the top sheet 300.

Furthermore, the respective lens 1 shown in FIGS. 20 to 22 preferably comprises an at least partially transparent bottom wall 6 connected to the frame structure 3 (for example to the further sheet 301) so that the lens volume V is arranged between said area 4a of the membrane 4 and said bottom wall 6. Further, the respective lens 1 preferably comprises an elastically deformable wall member 4b adjacent the reservoir volume R1.

Particularly, the lens 1 can comprises a further transparent and elastically deformable membrane 60 connected to the frame structure 3 (for example to the further sheet 301) on an opposite side with respect to the membrane 4, wherein the further membrane 60 is comprised by the bottom wall 6.

Furthermore, the bottom wall 6 may comprise a transparent rigid plate 61 that can be arranged on the further membrane 60, so that the further membrane 60 is arranged between the frame structure 3 and the rigid plate 61 that may comprise a circular shape. The container 2 may comprise a further rigid bottom element 63 adjacent the rigid plate 31, wherein the bottom element 63 can be opaque. Also here, the membranes 4, 60 can form interfaces between the respective components and act as a mechanical buffer, respectively.

Furthermore, as shown in FIGS. 23 and 24, the lens shaping element 5 can also be formed by a ring member 5 instead of a plate-like structure comprising through-holes.

According to FIG. 23, the lens shaping member 5 can be attached to an exterior side 40a of the membrane such that the membrane 4 particularly comprises a free portion extending around the ring member 5. Such a ring member 5 can be formed out of a metal or out of silicon.

In principle, the lens shaping member 5 can move with the membrane 4, but due to the comparatively short free membrane length between the frame structure 3 and the lens shaping element, the lens shaping element/ring member 5 will hardly move when the fluid F1 (e.g. liquid) is pumped into the lens volume V or transferred to the reservoir volume R1.

FIG. 24 shows an alternative embodiment of the lens 1 of FIG. 23, wherein in FIG. 24, the lens shaping element/ring member 5 is attached to an interior side 40a of the membrane 4 of the lens 1.

The lens shaping element 5 can be arranged on a step of the frame structure 3. Furthermore, the ring member 5 can be slightly higher than the frame structure around the ring member 5, so that the membrane 4 slightly presses on the lens shaping element 5 (prestrain of the membrane 4) and a mechanical play is suppressed.

1.-50. (canceled)

51. A lens having an adjustable optical power, wherein the lens comprises a container, wherein the container comprises:
a lens volume filled with a transparent fluid,
a reservoir volume filled with the transparent fluid and connected to the lens volume,
a frame structure forming a lateral wall of the container, wherein the frame structure comprises a first recess for accommodating at least a portion of the lens volume, and wherein the frame structure comprises a second recess for accommodating at least a portion of the reservoir volume,
an elastically deformable and transparent membrane connected to the frame structure,
a lens shaping element connected to the membrane, wherein the lens shaping element comprises a circumferential edge defining an area of the membrane having an adjustable curvature,
a transparent bottom wall connected to the frame structure so that the lens volume is arranged between said area of the membrane and said bottom wall, and
an elastically deformable wall member adjacent the reservoir volume
wherein the elastically deformable wall member forms a portion of said bottom wall, wherein the elastically deformable wall is formed by the further membrane, and wherein the membrane comprises a larger thickness than the further membrane to reduce a gravity-induced coma aberration of the area of the membrane, and/or
wherein the container encloses a further lens volume filled with a further transparent fluid, wherein the further lens volume is separated from the lens volume by a transparent and elastically deformable separating membrane, such that the further fluid is arranged between the fluid of the lens volume and the bottom wall, wherein for compensating a gravity-induced coma aberration of said area of the membrane, the further fluid comprises a density and a refractive index, wherein the density of the further fluid is smaller than a density of the fluid, and wherein the refractive index of the further fluid is larger than a refractive index of the fluid.

52. The lens according to claim 1, wherein the elastically deformable wall member is configured to be deformed to pump fluid from the reservoir volume into the lens volume to change a curvature of said area of the membrane and therewith an optical power of the lens, and/or wherein the wall member is configured to be deformed to pump fluid from the lens volume into the reservoir volume to change a curvature of the said area of the membrane and therewith an optical power of the lens, and wherein the lens comprises a piston structure connected to said deformable wall member for deforming the wall member by pushing against the wall member or by pulling on the wall member, wherein the piston structure is configured to be connected to an actuator for moving the piston structure.

53. The lens according to claim 1, wherein the reservoir volume of the container is arranged laterally next to the lens volume of the container in a direction perpendicular to the optical axis of the lens.

54. The lens according to claim 1, wherein the frame structure is formed by at least one monolithic plate member.

55. The lens according to claim 1, wherein the frame structure comprises a top sheet connected to the membrane and a further sheet connected to the top sheet, wherein the further sheet comprises an inner diameter that is smaller than an inner diameter of the top sheet so that an internal side of the frame structure of the container forms a step.

56. The lens according to claim 1, wherein the lens comprises a further transparent and elastically deformable membrane connected to the frame structure, wherein the further membrane is comprised by the bottom wall, wherein the bottom wall comprises a transparent plate arranged on the further membrane, so that the further membrane is arranged between the frame structure and the transparent plate.

57. The lens according to claim 1, wherein the lens shaping element comprises a first through-opening forming said circumferential edge, wherein the first through-opening is closed by said area of the membrane.

58. The lens according to claim 7, wherein the first recess of the frame structure comprises an inner diameter that is larger than an inner diameter of the circumferential edge of the first through-opening of the lens shaping element.

59. The lens according to claim 1, wherein the lens shaping element is a ring member that is attached to an exterior side of the membrane or to an interior side of the membrane, wherein the ring member comprises a through-opening forming said circumferential edge, wherein the through-opening is closed by said area of the membrane.

60. The lens according to claim 1, wherein the lens shaping element comprises a second through-opening, wherein the second through-opening is closed by the elastically deformable wall member.

61. The lens according to claim 1, wherein the frame structure is configured to expand with increasing temperature to reduce a change in the optical power of the lens due to an increase of the volume of the fluid with increasing temperature and due to a decrease of the refractive index of the fluid with increasing temperature.

62. The lens according to claim 1, wherein for balancing an increase in optical power of the lens due to an increase of the volume of the fluid with increasing temperature and a decrease of the optical power due to a decrease of the refractive index of the fluid with increasing temperature, the reservoir volume is delimited by a tilted inside of the second recess of the frame structure so as to reduce the reservoir volume; and/or a channel providing a flow connection between the lens volume and the reservoir volume comprises a height along the optical axis of the lens, which height is smaller than a height of the lens volume and/or than a height of the reservoir volume along the optical axis of the lens; and/or wherein said channel comprises a width perpendicular to the optical axis of the lens that is smaller than a diameter of the reservoir volume and/or than a diameter of the lens volume.

63. The lens according to claim 1, wherein the container comprises an elastically deformable wall region adjacent the reservoir volume for compensating a thermal drift of the optical power of the lens, and wherein the lens comprises a compensation actuator configured to deform said elastically deformable wall region to counteract a thermal drift of the optical power of the lens.

64. The lens according to claim 1, wherein the container comprises a further reservoir volume connected to the lens volume of the container, wherein the container comprises an elastically deformable further wall member adjacent the further reservoir volume of the container.

65. The lens according to claim 14, wherein the reservoir volume and the further reservoir volume of the container face each other in a direction perpendicular to the optical axis of the lens and are arranged on opposite sides of the lens volume.

66. The lens according to claim 14, wherein the further wall member is formed by the transparent and elastically deformable membrane.

67. The lens according to claim 14, wherein the lens comprises a further piston structure connected to said further wall member for deforming the further wall member by pushing against the further wall member or pulling on the further wall member, wherein the further piston structure is configured to be connected to a further actuator for moving the further piston structure.

68. The lens according to claim 1, wherein the lens shaping element is formed out of silicon, particularly crystalline silicon.

69. An optical device, wherein the optical device comprises a lens according to claim 1, and wherein the optical device comprises a lens barrel comprising a circumferential wall surrounding an internal space of the lens barrel, wherein at least one rigid lens is arranged in said internal space of the lens barrel, and wherein the circumferential wall of the lens barrel comprises a first slot configured to receive the container of the lens in a form fitting manner such that said area of the membrane of the lens faces the at least one rigid lens of the lens barrel, wherein particularly the lens shaping element of the lens is configured to protect said area of the membrane of the lens upon insertion of the container of the lens into the first slot of the lens barrel.
